(19) United States
(12) Patent Application Publication
(10) Pub. No.: US 2005/0048336 A1
(43) Pub. Date: Mar. 3, 2005

(54) Fuel cell system, and operation and program for same

(76) Inventors: Yasuo Takebe, Kyoto (JP); Masatoshi Teranishi, Osaka (JP); Takashi Nakagawa, Osaka (JP); Makoto Uchida, Osaka (JP); Terutsugu Segawa, Osaka (JP)

Correspondence Address: MCDERMOTT WILL & EMERY LLP, 600 13TH STREET, N.W., WASHINGTON, DC, 20005-3096, US

(21) Appl. No.: 10/897,431

(22) Filed: Jul. 23, 2004

(30) Foreign Application Priority Data
Jul. 24, 2003 (JP) 2003-279403
Jul. 25, 2003 (JP) 2003-279831

(51) Int. Cl. H01M 8/04

(52) U.S. Cl. 429/22; 429/23; 429/26; 429/13

(57) ABSTRACT

An electrolyte fuel system, its operation and program and a recording medium associated with the program is disclosed. Embodiments include a fuel cell system having a load electric current changing means for changing an amount of load electric current that runs in one ore more fuel cells which are operated to generate electricity, a measurement means for measuring voltage responses to the change in said load electric current, a calculating means for calculating impedance of said one or more fuel cells based on said voltage responses measured, and a fuel cell control means for controlling condition for operation of said one or more fuel cells by utilizing calculation results retrieved by said calculating means.

### FIELD OF THE INVENTION

The present invention relates to an electrolyte fuel system, its operation and program and a recording medium associated with the program. The present invention is particularly applicable to detecting and reducing abnormal levels of electricity from being generated in a polymer electrolyte fuel system.

### BACKGROUND

A fuel cell generates electricity by supplying an oxygen-based oxidizer to a cathode and supplying a hydrogen-based fuel gas to an anode. The fuel cell is either comprised of a cathode and an anode, or a stack of multiple fuel cells that are connected in series. During operation, the voltage of the fuel cell is generally monitored to determine whether an abnormal level of electricity is being generated to avoid damage to the cell and improve its efficiency. However, it is often difficult to diagnose potential problems from simply monitoring the voltage.

In particular, it is very difficult to judge whether the decline in voltage of a fuel cell is caused by an increase in the gas diffusion resistance as, for example, by the result of some obstruction that places limits on the amount of gas diffusion, or by an increase in reaction resistance as, for example, by the result of a declining level of reactivity of the electrolyte poles.

One technique to diagnose the abnormal level of electricity that is being generated in a fuel cell is described in Laid Opened Patent No. 2002-367650, the entire disclosure of which is herein incorporated by reference hereby. Therein a method is described wherein a normal level of alternating impedance of the fuel cell at specific frequencies is first pre-calculated. Then, that impedance is compared to the alternating impedance found during the operation of the system at the corresponding frequencies.

For illustration, a conventional fuel cell system 1 is shown on FIG. 24. Each impedance measurement devices 71, 72, etc., up to 7n is connected to a corresponding polymer electrolyte fuel cell stacks (PEFC stacks) 21, 22, etc., to 2n respectively. Each impedance measurement device 71, 72, etc., to 7n measures the impedance of the stack it is connected to (21, 22, etc., to 2n respectively). This measurement is added to the alternating voltage generated by the impedance measurement devices 71, 72, etc., to 7n. At least two alternating voltages (5 Hz and 40 Hz) should be used to test the system. The diffusion resistance and reaction resistance are calculated from the impedance levels of the stacks 21, 22, etc., to 2n, one at 5 Hz and the other at 40 Hz.

To diagnose any abnormality of electricity that is being generated, it is necessary to precisely measure the impedance of the stacks. However, it is difficult to do so with the above mentioned conventional fuel cell system 1 because inverter 6 is connected to stacks 21, 22, etc., 2n in parallel. Therefore, the impedance of the inverter 6 should be subtracted from the impedance of the stacks in order to calculate an accurate impedance in the system. Since the inverter 6 is constantly switching, its load impedance changes frequently. Therefore, it is difficult to precisely calculate the impedance of the stacks 21, 22, etc., up to 2n, respectively by simply subtracting the impedance of the inverter 6. Moreover, it is required to monitor the state of each cell (PEFC cells) 31, 32, etc. up to 3m in order to operate the fuel cell system under optimum conditions.

However, in the above mentioned fuel cell system 1, although it is possible to measure the impedance of each stacks, it is difficult to deduce the state or an impedance of each fuel cell 31, 32, to 3m from the measured impedance of stacks 21, 22, to 2n.

If the impedance of each fuel cell 31, 32, etc, to 3m is identical, the impedance of each fuel cell could be calculated from the impedance of stacks 21, 22, etc, to 2n. However, in fact, fuel cells 31, 32, etc, to 3m that create the stacks 21, 22, etc, to 2n are all in a different state at the same time and therefore, the impedance of each fuel cell must be different. For this reason, it is almost impossible to calculate the impedance of each fuel cell 31, 32, etc, to 3m from the total impedance of stacks 21, 22, etc., to 2n.

In an abnormal case where the electricity generated by the stacks 21, 22, 23, etc, to 2n starts to degenerate, a part of the fuel cell 31, 32, etc, to 3m would firstly show signs of abnormality. For this reason, it is believed that it is desirable to understand the situation of each fuel cell 31, 32, etc, to 3m in order to detect any abnormal operation in earliest stage of deterioration of the system, and therefore, to more safely and efficiently control the system.

In short, it is advantageous to specifically find the position of the fuel cell 31, 32, etc., to 3m that is causing a problem in order to detect any abnormal operation. It may not be enough to only to measure impedance of each stacks 21, 22, etc., to 2n in order to sufficiently diagnose the abnormality.

It would be virtually possible to find the impedance of each fuel cell 31, 32, etc, to 3m if an impedance measurement device is connected to each of fuel cells. However, the number of impedance measurement devices required to measure each fuel cell would be too high, and it would only increases the cost for the system. As a result, there have been no highly reliable methods to find the causes of an abnormal operating fuel cell system, particularly with regard to the amount of electricity generated in fuel cells.

Hence a continuing need exists to provide a fuel cell system, an operation method for the same, a program for the operation and a recording medium for the program, that would reliably track the causes of any abnormalities found in the amount of electricity generated in view of the problems of the above mentioned conventional fuel cell system.

### SUMMARY OF THE DISCLOSURE

An advantage of the present invention is a fuel cell and process that facilitates detection and analysis of voltages and other cell parameters and the ability to readily take appropriate action when abnormal levels of electricity is generated from the cell.

According to the present invention, the foregoing and other advantages are achieved in part by a fuel cell system comprising: a load electric current changing means for changing an amount of load electric current that runs in one or more fuel cells which are operated to generate electricity, a measurement means for measuring the voltage responses to the change in the load electric current, a calculating means for calculating the impedance of the one or more fuel cells based on the voltage responses measured, a fuel cell that utilizes the calculation results retrieved to change the operating conditions for the fuel cell.

A second embodiment of the present invention is a fuel cell system based on the first embodiment, wherein the calculation uses Capacitance C₁, Resistance R₁, Capacitance C₂, Resistance R₂, Capacitance C₃ and Resistance R₃, in a case of the fuel cell's equivalent circuit consisting of a series circuit of (1) a resistor having Resistance R_{S}, (2) a parallel circuit of a capacitor having Capacitance C₁ and a resistor having Resistance R₁ corresponding to the reaction impedance of an anode of the fuel cell, (3) a parallel circuit of a capacitor having Capacitance C₂ and a resistor having Resistance R₂ corresponding to the reaction impedance of a cathode of the fuel cell and (4) a capacitor having Capacitance C₃ and a resistor having Resistance R₃ that are connected in parallel.

A third embodiment of the present invention is a fuel cell system based on the second embodiment, wherein a volume of air bleed in the fuel gas provided to a prescribed fuel cell is increased if the combination (C₁, R₁) of Capacitance C₁ and Resistance R₁ is within the domain defined by the Expression 1 using constants a₁^{(L)} and b₁^{(L)} on the plane with Capacitance C₁ on the horizontal axis and Resistance R₁ on the vertical axis.
C₁≦a₁^{(L)}R₁+b₁^{(L)} (Expression 1)

A forth embodiment of the present invention is a fuel cell system based on the third embodiment, wherein an alarm triggers off and the operation is stopped if the combination (C₁, R₁) is within the prescribed domain even if the volume of the air bleed is increased.

A fifth embodiment of the present invention is a fuel cell system based on the second embodiment, wherein the volume of air bleed in fuel gas provided to the prescribed fuel cell is decreased if the combination (C₁, R₁) of Capacitance C₁ and Resistance R₁ is within the domain defined by the Expression 2 using constants a₁^{(U)} and b₁^{(U)} on the plane with Capacitance C₁ on the horizontal axis and Resistance R₁ on the vertical axis.
a₁^{(U)}R₁+b₁^{(U)}≦C₁ (Expression 2)

A sixth embodiment of the present invention is a fuel cell system based on the second embodiment, wherein the utilizing ratio of a fuel in a fuel gas provided to the prescribed fuel cell is increased if the combination (C₁, R₁) of Capacitance C₁ and Resistance R₁ is within the domain defined by the Expression 3 using constants c₁^{(L)} and d₁^{(L)} on the plane with Capacitance C₁ on the horizontal axis and Resistance R₁ on the vertical axis.
R₁≦c₁^{(L)}C₁+d₁^{(L)} (Expression 3)

A seventh embodiment of the present invention is a fuel cell system based on the sixth embodiment, wherein the domain is defined by the Expression 4 using not only the constants c₁^{(L)} and d₁^{(L)} but also constants a₁^{(L)}, b₁^{(L)}, a₁^{(U)} and b₁^{(U)}.
R₁≦c₁^{(L)}C₁+d₁^{(L)}
a₁^{(L)}R₁+b₁^{(L)}≦C₁≦a₁^{(U)}R₁+b₁^{(U)} (Expression 4)

A eighth embodiment of the present invention is a fuel cell system based on the second embodiment, wherein the utilizing ratio of a fuel gas in fuel gas provided to the prescribed fuel cell is decreased if the combination (C₁, R₁) of Capacitance C₁ and Resistance R₁ is within the domain defined by the Expression 5 using constants c₁^{(U)} and d₁^{(U)} on the plane with Capacitance C₁ on the horizontal axis and Resistance R₁ on the vertical axis.
c₁^{(U)}C₁+d₁^{(U)}≦R₁ (Expression 5)

A ninth embodiment of the present invention is a fuel cell system based on the eighth embodiment, wherein the domain is defined by the Expression 6 using not only the constants c₁^{(U)} and d₁^{(U)} but also constants a₁^{(L)}, b₁^{(L)}, a₁^{(U)} and b₁^{(U)}.
c₁^{(U)}C₁+d₁^{(U)}≦R₁
a₁^{(L)}R₁+b₁^{(L)}≦C₁≦a₁^{(U)}R₁+b₁^{(U)} (Expression 6)

A tenth embodiment of the present invention is a fuel cell system based on the second embodiment, wherein the cathode electrode of the fuel is recovered if the combination (C₂, R₂) of Capacitance C₂ and Resistance R₂ is within the domain defined by the Expression 7 using constants a₂^{(L)} and b₂^{(L)} on the plane with Capacitance C₂ on the horizontal axis and Resistance R₂₁ on the vertical axis.
C₂≦a₂^{(L)}R₂+b₂^{(L)} (Expression 7)

A eleventh embodiment of the present invention is a fuel cell system based on the tenth embodiment, wherein a prescribed alarm triggers off and the operation is stopped if the combination (C2, R2) is within the prescribed domain even if the prescribed time passes after the performance of the prescribed recovery.

A twelfth embodiment of the present invention is a fuel cell system based on the second embodiment, wherein a volume of humidification in a prescribed oxidizer gas provided to the fuel cell is decreased when the combination (C₂, R₂) of Capacitance C₂ and Resistance R₂ is within the domain defined by the Expression 8 using constants c₂^{(L)} and d₂^{(L)}on the plane with Capacitance C₂ on the horizontal axis and Resistance R₂₁ on the vertical axis.
R₂≦c₂^{(L)}C₂+d₂^{(L)} (Expression 8)

A thirteenth embodiment of the present invention is a fuel cell system based on the twelfth embodiment, wherein the domain is defined by the Expression 9 using not only the constants c₂^{(L)} and d₂^{(L)} but also constants a₂^{(L)} and b₂^{(L)}.
R₂≦c₂^{(L)}C₂+d₂^{(L)}
a₂^{(L)}R₂+b₂^{(L)}≦C₂ (Expression 9)

A fourteenth embodiment of the present invention is a fuel cell system based on the second embodiment, wherein a volume of humidification in the prescribed oxidizer gas provided to the fuel cell is increased in a case when the combination (C₂, R₂) of Capacitance C₂ and Resistance R₂ is within the domain defined by the Expression 10 using constants c₂^{(U)} and d₂^{(U)}.
c₂^{(U)}C₂+d₂^{(U)}≦R₂ (Expression 10)

A fifth embodiment of the present invention is a fuel cell system based on the fourteenth embodiment, wherein the domain is defined by the Expression 11 using not only the constants c₂^{(U)} and d₂^{(U)} but also constants a₂^{(L)} and b₂^{(L)}.
C₂^{(U)}C₂+d₂^{(U)}≦R₂
A₂^{(L)}R₂+b₂^{(L)}≦C₂ (Expression 11)

A sixteenth embodiment of the present invention is a fuel cell system based on the second embodiment, wherein the volume of cooling water provided to the fuel cell is decreased when the combination (C₃, R₃) of Capacitance C₃ and Resistance R₃ is within a domain defined by the Expression 12 using constants a₃^{(L)} and b₃^{(L)}.
C₃≦a₃^{(L)}R₃+b₃^{(L)} (Expression 12)

A seventeenth embodiment of the present invention is a fuel cell system based on the sixteenth embodiment, wherein the domain is defined by the Expression 13 using not only the constants a₃^{(L)} and b₃^{(L)} but also constants c₃^{(L)}, d₃^{(L)}, C₃^{(U)} and d₃^{(U)}.
C₃≦a₃^{(L)}R₃+b₃^{(L)}
a₃^{(L)}C₃+d₃^{(L)}≦R₃≦c₃^{(U)}C₃+d₃^{(U)} (Expression 13)

A eighteenth embodiment of the present invention is the fuel cell system based on the second embodiment, wherein a volume of cooling water provided to the fuel cell is increased if the combination (C₃, R₃) of Capacitance C₃ and Resistance R₃ is within the domain defined by the Expression 14 using constants a₃^{(U)} and b₃^{(U)}.
a₃^{(U)}R₃+b₃^{(U)}≦C₃ (Expression 14)

A nineteenth embodiment of the present invention is the fuel cell system based on the eighteenth embodiment, wherein the domain is defined by the Expression 15 using not only the constants a₃^{(U)} and b₃^{(U)} but also constants c₃^{(L)}, d₃^{(L)}, c₃^{(U)} and d₃^{(U)}.
a₃^{(U)}R₃+b₃^{(U)}≦C₃
c₃^{(L)}C₃+d₃^{(L)}≦R₃≦c₃^{(U)}C₃+d₃^{(U)} (Expression 15)

A twentieth embodiment of the present invention is a fuel cell system according to the second embodiment, wherein the utilizing ratio of an oxidizer gas in a prescribed oxidizer gas provided to the fuel cell is increased if the combination (C₃, R₃) of Capacitance C₃ and Resistance R₃ is within a domain defined by the Expression 16 using constants c₃^{(L)} and d₃^{(L)} on the plane coordinates having the horizontal axis in relation to Capacitance C₃ and the vertical axis in relation to Resistance R₃.
R₃≦c₃^{(L)}C₃+d₃^{(L)} (Expression 16)

A twenty first embodiment of the present invention is a fuel cell system based on the second embodiment, wherein the utilizing ratio of an oxidizer gas in the prescribed oxidizer gas provided to the fuel cell is decreased if the combination (C₃, R₃) of Capacitance and a constant d₃^{(U)} on the plane with Capacitance C₃ on the horizontal axis and Resistance R₃ on the vertical axis.
c₃^{(U)}C₃+d₃^{(U)}≦R₃ (Expression 17)

A twenty second embodiment is a fuel cell system based on the twenty first embodiment, wherein the prescribed alarm triggers off and the operation of the fuel cell is continued with a decreased utilizing ratio of oxidizer gas if the utilizing ratio of oxidizer gas is decreased for more than the prescribed time.

A twenty third embodiment of the present invention is a fuel cell system based on the first embodiment, wherein a impedance of the fuel cell is calculated by using Capacitance C₁′, Resistance R¹′, Capacitance C₂′, Resistance R₂′, Resistance W_{2R}′ and Resistance R₃′ in a case of the fuel cell's equivalent circuit consisting of a series circuit of (1) a parallel circuit of capacitor with Capacitance C₁′ corresponding to the capacitance of electric dual layers of the anode and a resistor having Resistance R₁′ corresponding to the reaction resistance of the anode, (2) a parallel circuit of (2a) a capacitor having Capacitance C₂′ corresponding to capacitance of electric dual layers of the anode and (2b) a series circuit of a resistor having Resistance R₂′ corresponding to reaction resistance of the anode of the fuel cell and a whorl burg resistor having Resistance R_{2R}′ corresponding to diffusion resistance of the cathode and (3) a resistor having Resistance R₃′ corresponding to resistance of a polymer membrane of the fuel cell.

A twenty fourth embodiment of the present invention is a fuel cell system based on the twenty third embodiment, wherein a volume of air bleed in the fuel gas provided to the prescribed fuel cell is increased when the Capacitance C₁′ is smaller than the prescribed smallest limit.

A twenty fifth embodiment of the present invention is a fuel cell system based on the twenty fourth embodiment, wherein a prescribed alarm starts and the operation of the fuel cell is stopped in a case when the Capacitance C₁′ is smaller than the prescribed smallest limit even if the volume of the air bleed is increased.

A twenty sixth embodiment of the present invention is a fuel cell system based on the twenty third embodiment, wherein the volume of air bleed in the prescribed fuel gas provided the fuel cell is decreased if Capacitance C1 is larger than the prescribed largest limit.

A twenty seventh embodiment of the present invention is a fuel cell system based on the twenty third embodiment, wherein the utilizing ratio of fuel gas in the prescribed fuel gas provided to the prescribed fuel cell is increased if Resistance R₁′ is smaller than the prescribed smallest limit.

A twenty eighth embodiment of the present invention is a fuel cell system based on the twenty third embodiment, wherein the utilizing ratio of fuel gas in the fuel gas provided to the prescribed fuel cell is decreased if Resistance R₁′ is larger than the prescribed largest limit.

A twenty ninth embodiment of the present invention is a fuel cell system based on the twenty third embodiment, where a prescribed recovery is performed in relation to a catalyst of a cathode electrode in the fuel cell if Capacitance C₂′ is smaller than the prescribed smallest limit.

A thirtieth embodiment of the present invention is a fuel cell system based on the twenty ninth embodiment, wherein the prescribed alarm starts outward and the operation of the fuel cell is stopped in a case when Capacitance C₂′ is smaller than the prescribed smallest limit when the prescribed time has past after the performance of the prescribed recovery.

A thirty first embodiment of the present invention is a fuel cell system based on the twenty third embodiment, wherein the volume of humidification in the oxidizer gas provided to the prescribed fuel cell is decreased if Resistance R₂′ is smaller than the prescribed smallest limit.

A thirty second embodiment of the present invention is a fuel cell system based on the twenty third embodiment, wherein the volume of humidification in the oxidizer gas provided to the prescribed fuel cell is increased if Resistance R₂′ is larger than the prescribed largest limit.

A thirty third embodiment of the present invention is a fuel cell system based on the twenty third embodiment, wherein the utilizing ratio of oxidizer gas in the prescribed oxidizer gas provided to the fuel cell is increased if Resistance W_{2R}′ is smaller than the prescribed smallest limit.

A thirty fourth embodiment of the present invention is a fuel cell system based on the twenty third embodiment, wherein the utilizing ratio of oxidizer gas in the prescribed oxidizer gas provided to the fuel cell is increased if Resistance W_{2R}′ is smaller than the prescribed smallest limit.

A thirty fifth embodiment of the present invention is a fuel cell system based on the thirty fourth embodiment, wherein the volume of cooling water provided to the fuel cell is decreased if the utilizing ratio of oxidizer gas is decreased more than the prescribed times.

A thirty sixth embodiment of the present invention is a fuel cell system based on the thirty fifth embodiment, wherein the prescribed alarm starts and the operation of the fuel cell is continued after the utilizing ratio of oxidizer gas is further decreased if the volume of cooling water provide to the fuel cell is decreased more than the prescribed.

A thirty seventh embodiment is a fuel cell system based on the twenty third embodiment, the volume of cooling water provided to the fuel is increased if Resistance R₃′ is larger than the prescribed largest limit.

A thirty eighth embodiment of the present invention is a fuel cell system based on the first embodiment, wherein the load electric current is replaced by an alternating current that is placed over the direct current and is outputted from the fuel cell, the changes in the load electric current is replaced by the changes in the frequencies of the alternating current and the calculation in relation to impedance is done based on the results of impedance of the fuel cell at multiple frequencies of the alternating current.

A thirty ninth embodiment of the present invention is a fuel cell system based on the first embodiment, wherein the prescribed load electric current is fluctuated at a constant difference, and calculation of impedance is achieved from a frequency function found by using Fourier's transformation on the fluctuating load electric current and a time function found by using Fourier's transformation on the voltage response to the changes in the load electric current.

A fortieth embodiment of the present invention is a fuel cell system based on the first embodiment, wherein the fuel cell consists of multiple cells, the impedance is measured for every cell while a control changes the condition for operation for every cell.

A forty first embodiment of the present invention is a fuel cell system based on the fortieth embodiment, further comprising: a first wire to connect multiple cells while allowing changing amount of electricity to run or flow therethrough, a second wire to connect the measurement device and the multiple cells, a switching means to switch the connection between the multiple cells and the first wire on or off, and between the multiple cells and the second wire on and off, and a controlling means for controlling the connections of the first and the second wires by utilizing predetermined control signals.

A forty second embodiment of the present invention is a fuel cell system based on the first embodiment, wherein the fuel cell is connected to an AC/DC inverter in series.

A forty third embodiment of the present invention is a fuel cell comprising: a load electric current step device that fluctuates the amount of load electric current generated at predetermined levels which are then supplied to the fuel cell for operatation, a measurement means for measuring the voltage responses corresponding to changes in the load electric current, a calculation means for calculating the impedance of the fuel cells based on the result of the measurement in the voltage responses and a fuel cell controlling means for changing the conditions for the operation of the fuel cell by utilizing the results of the calculation of the impedance.

A forty fourth embodiment of the present invention is a program that allows a computer to execute the operation method based on the forty third embodiment having, a load electric current changing step for changing the amount of load electric current supplied to a fuel cell to operate, a calculation step for calculating the impedance of the fuel cell based on a result of measurement in the voltage responses and a fuel cell controlling step for changing the conditions for the operation of the fuel cell by utilizing the result of the calculation of the impedance.

A forty fifth embodiment of the present invention is a recording medium on which the data generated by the program based on the forty fourth embodiment is recorded.

Additional advantages of the present invention will become readily apparent to those skilled in this art from the following detailed description, wherein only the preferred embodiments of the invention are shown and described, simply by way of illustration of the best mode contemplated of carrying out the invention. As will be realized, the invention is capable of other and different embodiments, and its several details are capable of modifications in various obvious respects, all without departing from the invention. Accordingly, the drawings and description are to be regarded as illustrative in nature, and not as restrictive.

### BRIEF DESCRIPTION OF THE DRAWINGS

The various features and advantages of the present invention will become more apparent and facilitated by reference to the accompanying drawings, submitted for purposes of illustration and not to limit the scope of the invention, where the same numerals represent like structure and wherein:

FIG. 1 is a diagram showing the structure for a fuel cell system in accordance with embodiments of the present invention.

FIG. 2 is a diagram showing impedance plotted at different frequencies in accordance with embodiments of the present invention.

FIG. 3 is a diagram showing an equivalent circuit showing a fuel cell's impedance in accordance with embodiments of the present invention.

FIG. 4 is a diagram showing relationship between the ratio of alternating current's amplitude and direct current, as well as S/N ratio in accordance with embodiments of the present invention.

FIG. 5 is a diagram illustrating a cole-cole plot in accordance with embodiments of the present invention.

FIG. 6 is a diagram showing plots of the combination pairs in an equivalent circuit when changing the air utilizing ratio in accordance with embodiments of the present invention.

FIG. 7 is a flow chart to explain the system control no. 1 in accordance with embodiments of the present invention.

FIG. 8 is a flow chart to explain the system control no. 2 in accordance with embodiments of the present invention.

FIG. 9 is a flow chart to explain the system control no. 3 in accordance with embodiments of the present invention.

FIG. 10 is a diagram showing the area of (C₃, R₃) in accordance with embodiments of the present invention.

FIG. 11 is a diagram showing the area of (C₂, R₂) in accordance with embodiments of the present invention.

FIG. 12 is a diagram showing the area of (C₁, R₁) in accordance with embodiments of the present invention.

FIG. 13 is a diagram showing the structure of a fuel cell system in accordance with a second embodiment of the present invention.

FIG. 14 is a diagram showing the structure of a fuel cell system in accordance with a third embodiment of the present invention.

FIG. 15 is a diagram showing the structure of a fuel cell system in accordance with a fourth embodiment of the present invention.

FIG. 16 is a diagram showing an auto connecting device 44 located in the cells in accordance with a fourth embodiment of the present invention.

FIG. 17 is a diagram showing a fuel cell's impedance in an equivalent circuit in accordance with a fourth embodiment of the present invention.

FIG. 18 is a diagram illustrating a cole-cole plot in accordance with a fourth embodiment of the present invention.

FIG. 19 is a flow chart for the system control no. 1 in accordance with a fourth embodiment of the present invention.

FIG. 20 is a flow chart for the system control no. 2 in accordance with a fourth embodiment of the present invention.

FIG. 21 is a flow chart for the system control no. 3 in accordance with a fourth embodiment of the present invention.

FIG. 22 is a diagram showing voltage changes in Example 1 and the comparison example.

FIG. 23 is a diagram showing voltage changes in Examples 2 to 6.

### DETAILED DESCRIPTION OF THE DISCLOSURE

The embodiments of the present invention are explained hereinafter with reference to the drawings.

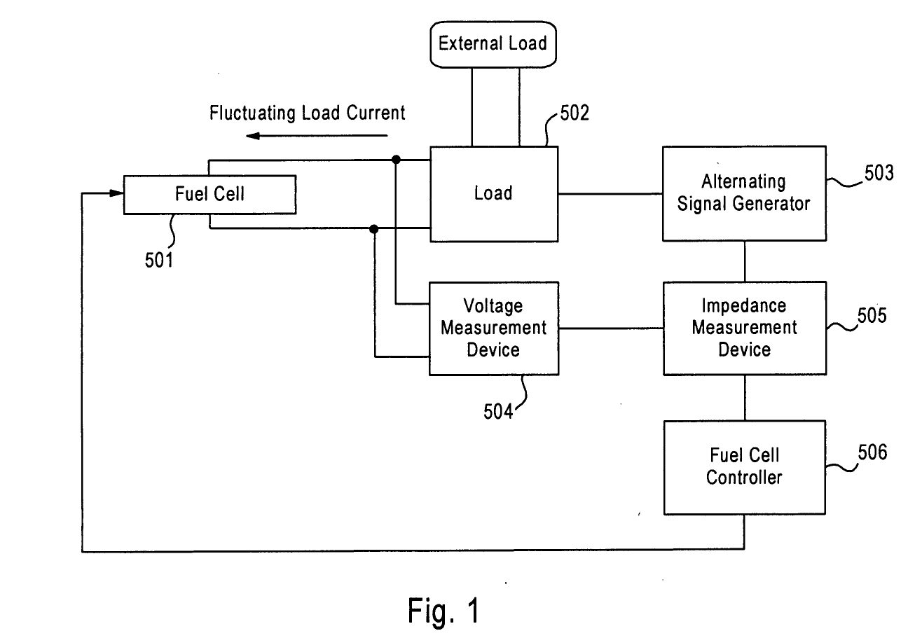

First, a construction of the first embodiment is explained hereinafter with reference mainly to FIG. 1. This figure shows the construction of a fuel cell system. The fuel cell system generates electricity by providing an oxygen-based oxidizer to a cathode and providing a hydrogen-based fuel gas to an anode. The fuel cell system contains an alternating signals generator 503 that generates alternating signals to change the amount of load electric current supplied to a fuel cell 501 and a voltage measurement device 504 that measures the voltage response of the fuel cell 501. An impedance measurement device 505 measures the impedance of the fuel cell 501 from phase differences between the load electric current and its voltage response so that conditions for the operation are changed corresponding to the measured impedance.

The load 502 (this corresponds to an AC/DC inverter used to transform direct current into alternating current, and the same hereinafter) is connected in series to the fuel cell 501, the target that is to be measured. This design can easily and precisely measure impedance of the fuel cell 501 while the fuel cell system is operating.

Next, the operation of the fuel cell system is explained as well as how the system works. The fuel cell 501 is connected to the load 502. The current flowing in the load 502 is controlled by the signals generated from an alternating signal generator 503. The fuel cell 501 receives the load current that is fluctuated by the frequencies of the alternating signal. A voltage measurement device 504 measures the changes in voltage of the fuel cell 501. An impedance measurement device 505 calculates the impedance from phase differences between the changes in the voltage and the alternating signals.

As explained in detail hereinafter, a fuel cell controller 506 controls the conditions for the operation of the fuel cell 501 in response to the values of the impedance. Although this figure describes a fuel cell having one cell, the present invention contemplates the a fuel cell stack comprising multiple cells piled together instead of a single cell and measuring the impedance of whole the fuel stack.

In an embodiment of the present invention, the fuel cell system can also include the load 502 and the alternating signals generator 503, which are used to change the amount of the load electric current, the voltage measurement device 504, the impedance measurement device 505, the fuel cell controller 506. The above description explained the construction and operation of the fuel cell system. Hereinafter, the logic behind the calculation of the impedance in the fuel cell system and logic behind determining the control conditions are explained in detail.

Fuel cells that can be used in the present invention are comprised of a hydrogen ion conductive electrolyte membrane and electrodes that are positioned on either sides of the membrane. This type of fuel cell is a polymer electrolyte. The cell has a separator with passages, which, on one side, provides fuel gas to and from an electrode (anode), and the other side of the separator provides gas containing oxygen to and from the other electrode (cathode). A fuel stack is comprised of several tens or hundreds of the such fuel cells, which can be arranged in a series such as by being piled on top of each other. The impedance of a particular fuel cell includes the impedance of the anode, cathode, membrane and impedance of each of the additional construction members.

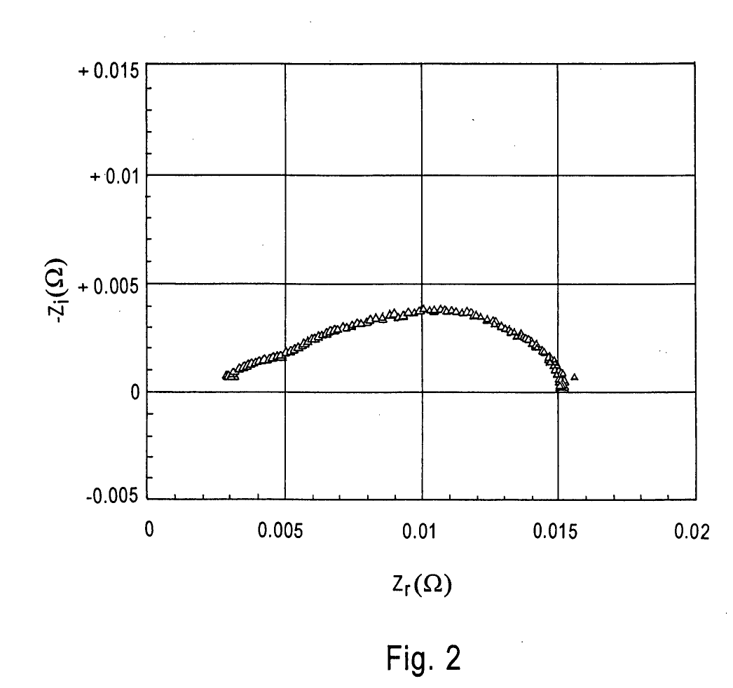

FIG. 2 shows the impedance measured at different frequencies in the fuel cell system. As explained later in detail, the drawing shows the plots of an imaginary number (its sign is reversed) of impedance against a real number of the impedance in a typical type of a fuel cell.

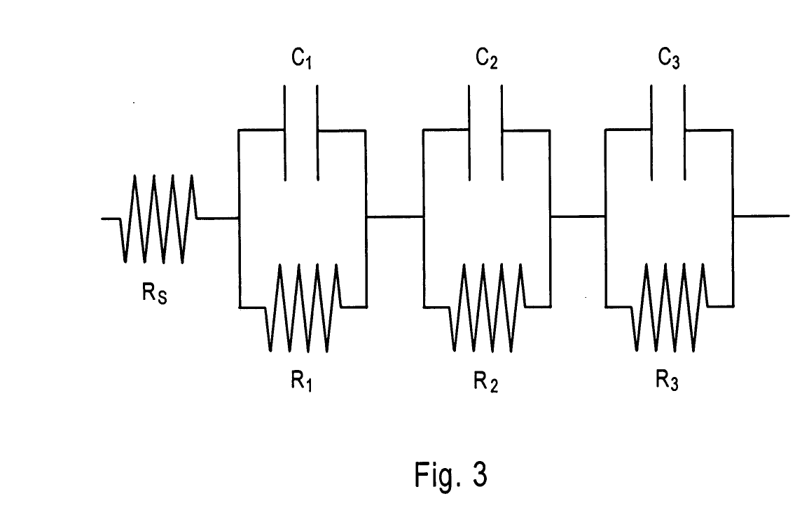

FIG. 3 shows an explanation of the circuit used to find impedance. It was discovered that this equivalent circuit can generate the impedance quite precisely. A measurement method for measuring impedance is hereafter explained.

An alternating current which has an amplitude smaller than about 10% of the amplitude of the direct current and frequency “f” is extracted by overlapping it on top of the direct current. It is supposed that a range of changes of the load electric current is about 0 to about 200% of the regular power output of the load electric current. The impedance is calculated from the alternating component of the measured cell voltage and the amplitude and the phase of the alternating component of a cell current measured at the same time. Normally, the bigger an amplitude of alternating current is, the better the ratio of signal to noise (Ratio of S/N) will be.

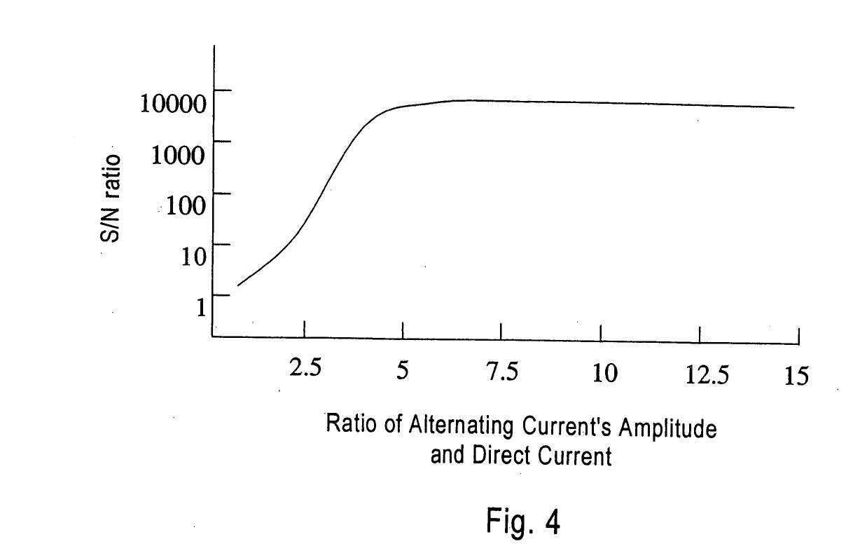

FIG. 4 shows the relationship between the ratio of amplitude of alternating current against direct current and a ratio of S/N. However, as shown in FIG. 4, even if the amplitude is increased, the ratio of S/N reaches a saturation plateau. Further improvements in the S/N ratio very slightly when the direct current is above 5%. On the other hand, since current flowing in the cell involves moving electrons by a chemical reaction in a fuel cell, the ratio of reaction volume to provided gas volume (a ratio of utilizing gas) is changed when the amplitude of alternating current is increased.

Normally, if the amplitude of alternating current added is less than 10% of direct current, changes in the ratio of utilizing gas are small and do not influence the result of the measurements greatly. If the amplitude of the alternating current added is more than 10% of the direct current, the changes in the ratio of utilizing gas cannot be ignored and leads to a large error in the results of the measurements. Therefore, it is preferable that the amplitude of alternating current added is between 5 and 10% of direct current for the above reasons.

A complex impedance of an equivalent circuit can be expressed by Z where, Zᵣ is its real number, and Zᵢ is its imaginary number with its sign reversed, as follows:
Z=Zᵣ−jZᵢ (Expression 18)
wherein “j” is an imaginary number unit and will be used hereafter as such. Further, the alternating cell voltage read at measurement can be expressed by E where, Er is its real number, and Eᵢ is its imaginary number with its sign reversed. The complex impedance at an alternating cell voltage can be represented by I, where Iᵣ is its real number, and Iᵢ is its imaginary number with its sign reversed. Then, E, I and Z are are related as follows:
   E=Eᵣ₋jEᵢ, I=Iᵣ−jIᵢ and
   Z=E/I=(Eᵣ−jEᵢ)/(Iᵣ−jIᵢ) (Expression 19)

Therefore, the complex impedance Z is calculated from E and I which are measured when alternating current is extracted at a frequency “f”.

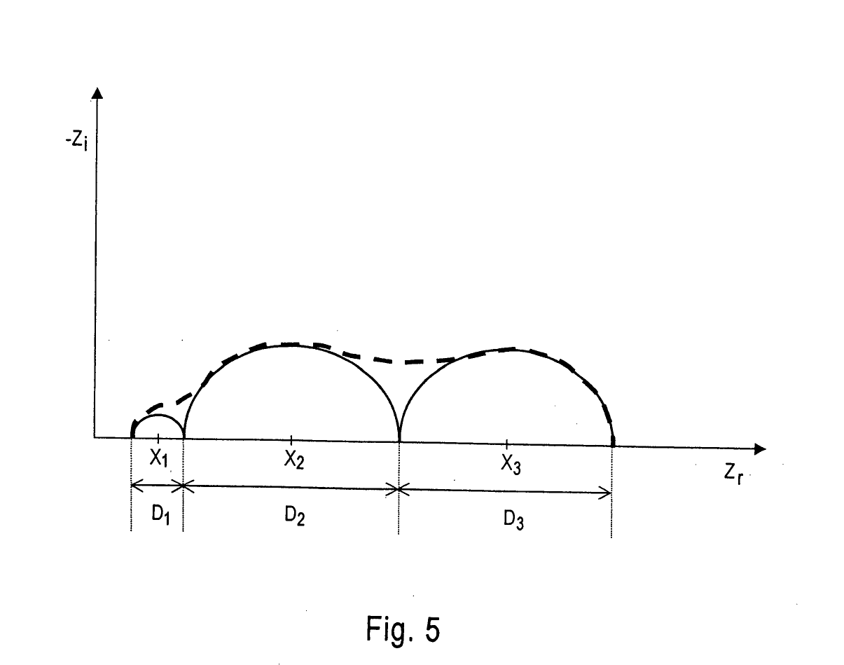

Further, the frequency “f” of the alternating current taken out is swept from 0.1 Hz to 1000 Hz and complex impedance at each frequency is calculated. It is preferred to sweep the frequency “f” from 0.01 Hz to 1 MHz. A real number Zr and imaginary number Zᵢ is plotted on a complex plane coordinates with real number Zr on the horizontal axis and imaginary number Zᵢ on the vertical axis with its sign reversed. FIG. 5 shows a cole-cole plot indicating dots of the combinations (Zᵣ, Zᵢ) calculated in this fuel cell system.

If an equivalent circuit includes a parallel circuit made from a resistor and a capacitor, a cole-cole plot results in a semi circular shape with its center on the vertical axis and a radius of constant length (a so-called a circular rule of cole-cole plot). If the equivalent circuit has a series circuit includes a resister having Resistant R₅, the first parallel circuit includes a resister having Resistant R₁ and a condenser having Capacitance C₁, the second parallel circuit includes a resister having Resistant R₂ and a condenser having Capacitance C₂, the third parallel circuit includes of a resister having Resistant R₃ and a condenser having Capacitance C₃ as shown on FIG. 3, its cole-cole plot is in a shape of composed of three semi circles.

In FIG. 5, three semi circles are shown in solid lines and the combination of all of the three semi circles is shown in a dotted line. Each semi-circles' radius and the center points are determined one by one, in the ascending order of frequency. As a result, the coordinates of the first, second, and third semi circles are expressed as X₁, X₂, X₃ and D₁, D₂, D₃. Then, the frequencies corresponding to the largest imaginary number on each semi circle
C₁=1/(2πf₁R₁)=1/(2πf₁D₁), C₂=1/(2πf₂R₂)=1/(2πf₂D₂),
C₃=1/(2πf₃R₃)=1/(2πf₃D₃),
Rₛ=X₁−D₁/2, R₁=D₁, R₂=D₂, R₃=D₃ (Expression 20)

This is how each component (C₁, R₁), (C₂, R₂), (C₃, R₃) of the equivalent circuit in the cole-cole plot can be calculated.

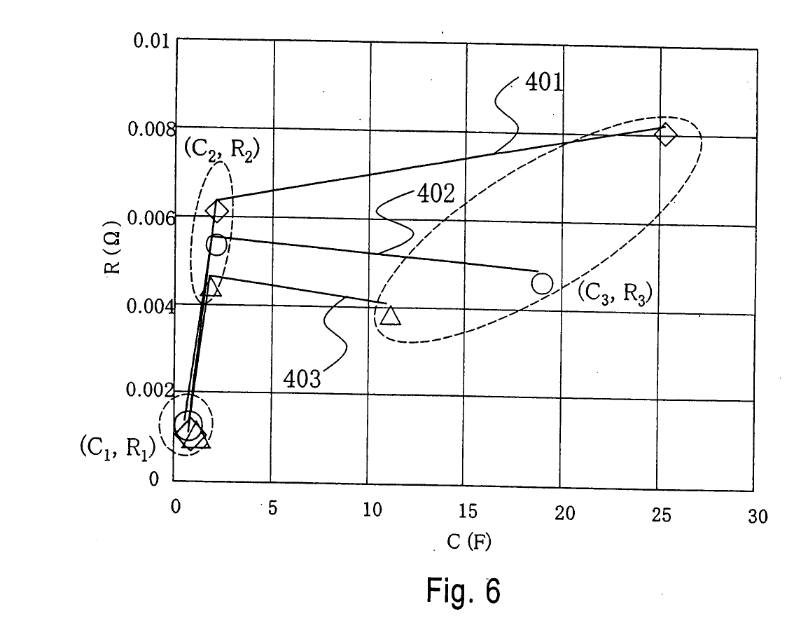

FIG. 6 shows another cole-cole plot of combinations of each components of the equivalent circuit with another utilizing ratio of air. An interrelation between Resistant R and Capacitance C in the equivalent circuit is shown in the figure. Further in FIG. 6, each of the combinations (C₁, R₁), (C₂, R₂), (C₃, R₃) is plotted with Capacitance C on the horizontal axis and Resistant R on the vertical axis. An interrelation between Resistant R and Capacitance C is determined by changing the conditions of the operation for the fuel cell.

In the FIG. 6, for easier understanding, the folded line 401 is a line connecting plots of the combinations (C₁, R₁), (C₂, R₂), (C₃, R₃) if the utilizing ratio of air is 60%, another folded line 402 is a line connecting plots of combinations (C₁, R₁), (C₂, R₂), (C₃, R₃) if the utilizing ratio of air is 40% and another folded line 403 is a line connecting plots of combinations (C₁, R₁), (C₂, R₂), (C₃, R₃) if the utilizing ratio of air is 20%. The dotted lines show the rough areas of the changes in each combinations (C₁, R₁), (C₂, R₂), (C₃ R₃).

When changing the concentration of hydrogen in the fuel gas, mainly Capacitance C₁ and Resistant R₁ were affected. When changing the temperature of the fuel cell, mainly Capacitance C₂ and Resistant R₂ were affected. According to the above observations, in a case of the equivalent circuit shown on the FIG. 3, it is found that Capacitance C₁ and Resistant R₁ correspond to the reaction impedance of the anode, Capacitance C₂ and Resistant R₂ correspond to the reaction impedance of the cathode and Capacitance C₃ and resistant R₃ correspond to the diffusion impedance of the cathode. As such, impedance of each cells is measured under normal operating conditions, and values of each component calculated from the impedances measured are noted in advance and included in the pre-calculated values. Then, it is possible to understand the condition of each cell during the operation and to control the operation of the fuel cell in the best possible way when an abnormality is detected by comparing the measured values to the pre-calculated values.

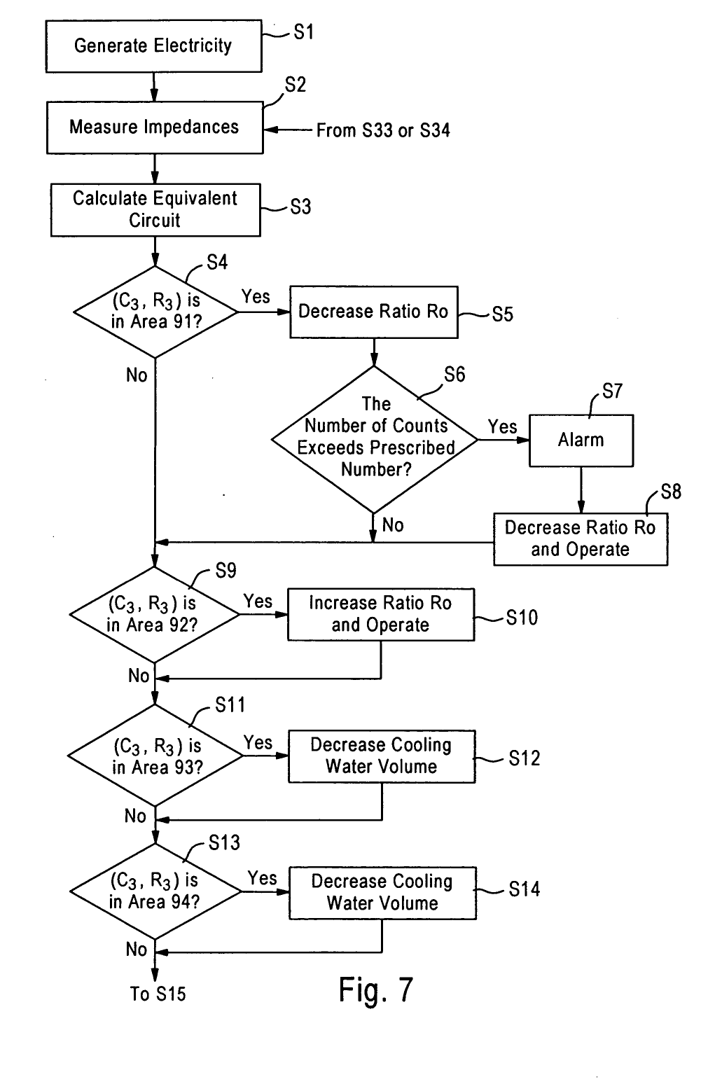

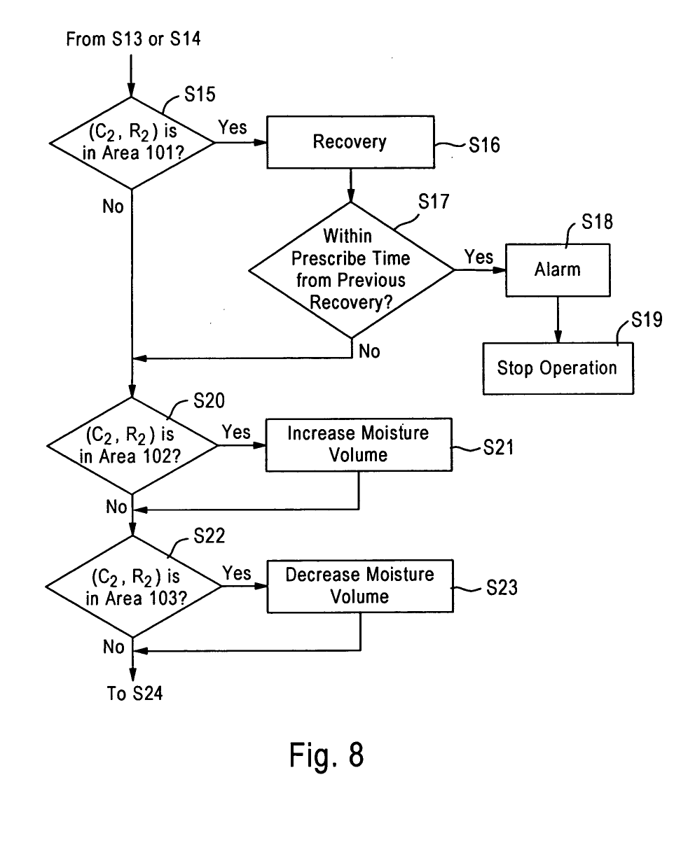

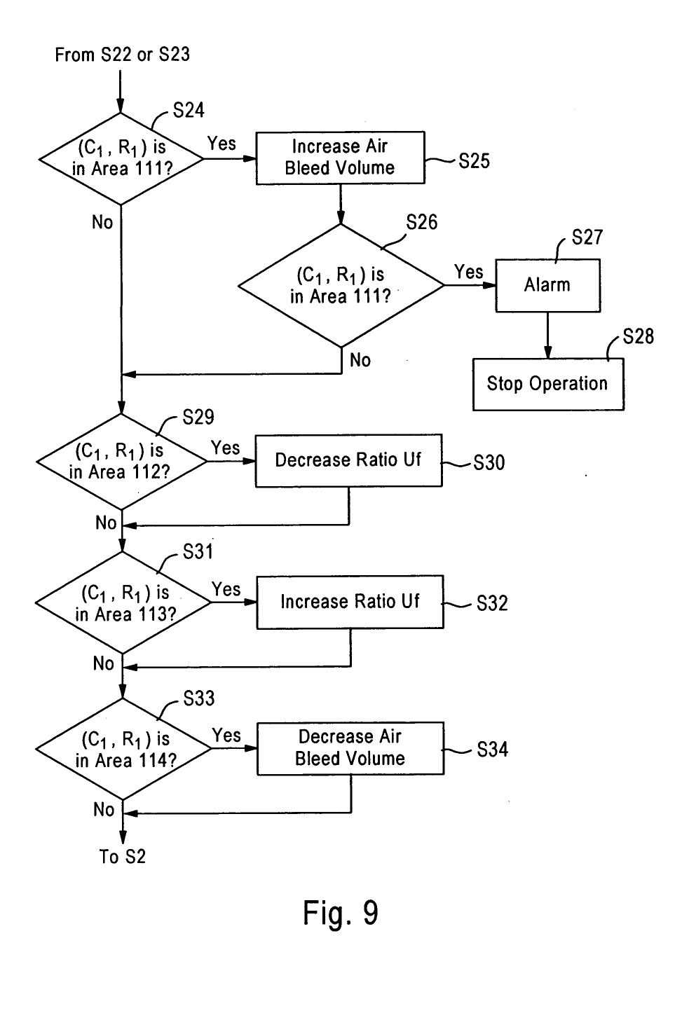

FIG. 7, FIG. 8 and FIG. 9 are flowcharts used to explain how to control the fuel cell system. Hereinafter, the steps of the control are explained in detail.

Step 1 to 3 (S1-S3): Impedances can be measured at any time after generating electricity has started. The value of each component in the equivalent circuit is calculated from the impedances values measured.

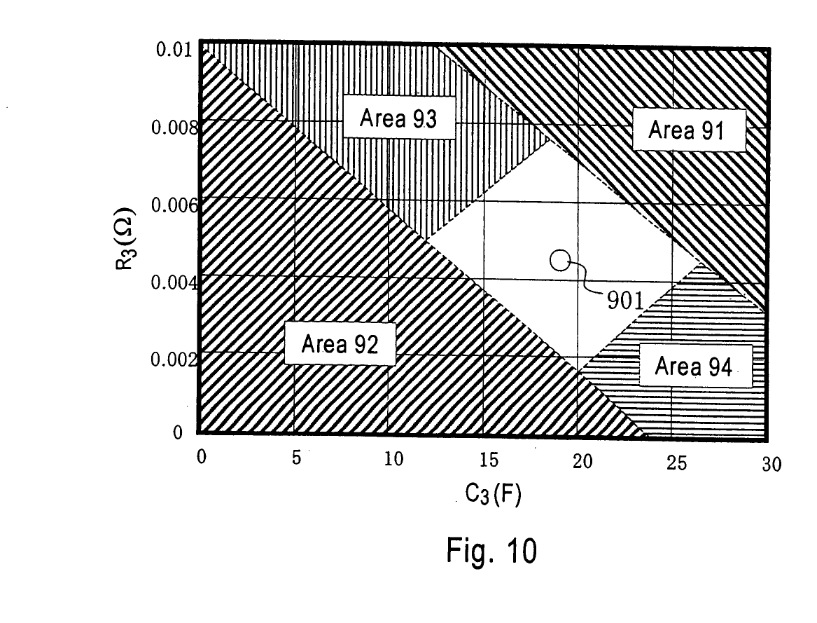

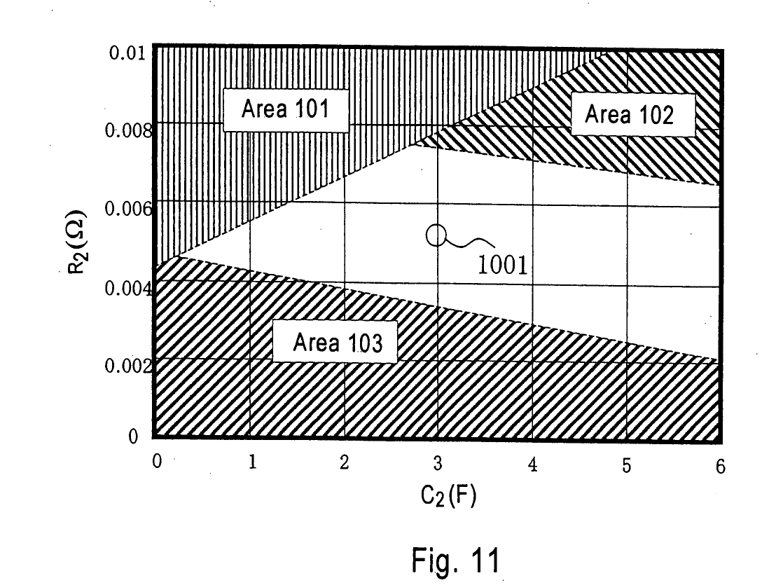

Step 4 to 8 (S4-S8): It is determined where the combination (C₃, R₃) in the equivalent circuit is in the FIG. 10, which explains the areas that the combination (C₃, R₃) can be positioned during operation. The combination (C₃, R₃) is a component based on the diffusion impedance of the cathode as explained above. The initial value 901 of the combination (C₃, R₃) corresponds to a normal value in FIG. 10. The area 91 is an area defined by Expression 21.
−0.00041C₃+0.015≦R₃ (Expression 21)

Area 92 is an area defined by Expression 22.
R3≦−0.00041C₃+0.0098 (Expression 22)

Area 93 is an area defined by Expression 23.
C₃≦2500R₃−0.5
−0.00041C₃+0.0098≦R₃≦−0.00041C₃+0.015 (Expression 23)

Area 94 is an area defined by Expression 24.
2500R₃+16≦C₃
−0.00041C₃+0.0098≦R₃≦−0.00041C₃+0.015 (Expression 24)

If the combination (C₃, R₃) moves into the area 91 because of increasing Resistant R₃, it is judged that the gas diffusion has decreased as a result of wetness. Then, the ratio U₀ of the utilizing air is decreased for the prescribed time period so that the wetness would disappear and Resistant R₃ is decreased to the normal state. The number of times the ratio U₀ of the utilizing air had to be decreased is counted and noted for future reference. If the number of this action is larger than the prescribed number, it is judged that the material of the electrode has deteriorated so much that the electrode is liable to be wet. Therefore, an alarm is triggered off and the operation of the fuel cell is continued under the condition of the low ratio U₀. The alarm is used for drawing the operator's attention to consider maintenance and to finding the cause of the abnormality during the maintenance.

Step 9 to 10 (S9-S10): If the combination (C₃, R₃) moves into area 92 because of decreasing Resistant R₃, it is judged that the material of the electrode has become dry. Therefore, the ratio U₀ of the utilizing air is increased to restrain the dryness in order that Resistant R₃ is increased.

Step 11 to 12 (S11-S12): If the combination (C₃, R₃) moves into area 93 because of decreasing Resistant C₃, it might be judged that the cause might be an increasing level of wetness. However, in this case, it is appropriate to assume that the cause is due to the decreased temperature of the fuel cell. Therefore, the volume of the cooling water is decreased to dispel the wetness. This, in turn, would increase Capacitance C₃.

Step 13 to 14 (S13-S14): To the contrary, if the combination (C₃, R₃) moves into area 94 because of increasing Capacitance C₃, the volume of the cooling water is increased to decrease the temperature of the fuel cell so that the dryness is restrained. This, in turn, would decrease Capacitance C₃. Although areas 91, 92, 93 and 94 are classified based on experience, the stable operation for the fuel cell system can be achieved if the operation follows the flow explained above (it is same hereinafter).

FIG. 11 shows areas where the combination (C₂, R₂) in the equivalent circuit is positioned. The combination (C₂, R₂) corresponds to the reaction impedance of the cathode. The initial value 1001 of the combination (C₂, R₂) corresponds to a normal value in FIG. 10. The area 101 is an area defined by Expression 25.
C₂≦1000R₂−5 (Expression 25)

Area 102 is an area defined by Expression 26.
−0.0005C₂+0.0093≦R₂
1000R₂−5≦C₂ (Expression 26)

Area 103 is an area defined by Expression 27.
R₂≦−0.0005C₂+0.005
1000R₂−5≦C₂ (Expression 27)

Step 15 to 19 (S15-S19): If the combination (C₂, R₂) moves into the area 101 because of decreasing Capacitance C₂, it is judged that the area of the cathode electrode in appearance is decreased because an action capability of the catalyst of the cathode electrode has decreased. Then, the control is recovered so that Capacitance C₂ is increased. The recovery involves shutting out air flow by providing the fuel gas to the load electric current or to gas with a lower pressure ratio of oxygen instead of air so that the voltage of the cathode is decreased (the voltage of the fuel cell is decreased). Then, the action capability of the catalyst of the cathode electrode is recovered. If the action capability of the catalyst is decreased in a short time after the previous recovery, an alarm triggers off and the operation is stopped since it is judged that the catalyst has deteriorated.

Step 20 to 21 (S20-S21): If the combination (C₂, R₂) moves into area 102 because of increasing Resistant R₂, it is judged that the action capability of the catalyst has decreased because of its dryness. Then, the amount of moisture in the air is increased to decrease Resistant R₂.

Step 22 to 23 (S22-S23): To the contrary, if the combination (C₂, R₂) moves into area 103 because of decreasing Resistant R₂, it is judged that the catalyst is too wet. Then, the amount of moisture in the air is decreased to increase Resistant R₂.

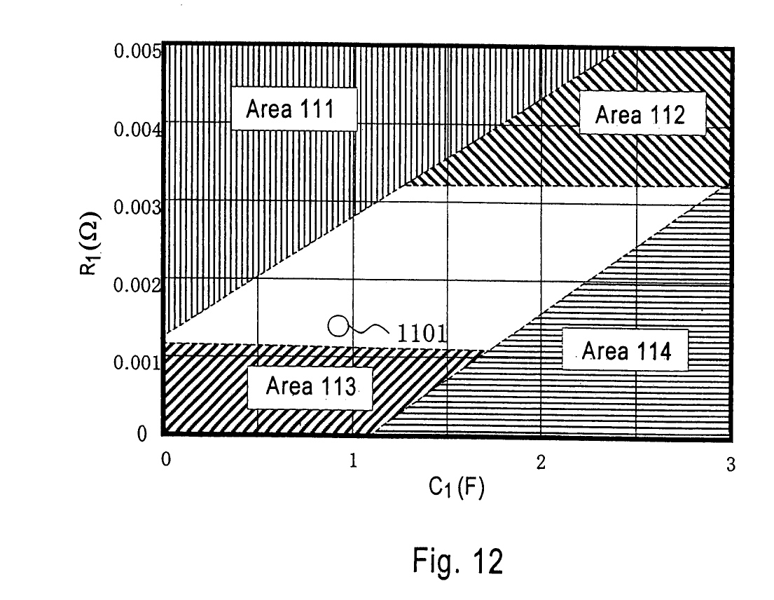

FIG. 12 shows areas where the combination (C₁, R₁) in the equivalent circuit is positioned. The combination (C₁, R₁) corresponds to the reaction impedance of the anode as explained above. The initial value 1101 of the combination (C₁, R₁) corresponds to a normal value in FIG. 12. The area 111 is an area defined by Expression 28.
C₁≦625R₂−0.75 (Expression 28)

Area 112 is an area defined by Expression 29.
0.0032≦R₁
625R₁−0.75≦C₁≦625R₁+1.1 (Expression 29)

Area 113 is an area defined by Expression 30.
R₁≦0.0011
625R₁−0.75≦C₁≦625R₁+1.1 (Expression 30)
625R₁+1.1≦C₁ (Expression 31)

Step 24 to 28 (S24-S28): If the combination (C₁, R₁) moves into the area 111 because of decreasing. Capacitance C₁, it is judged that the area of the anode electrode shown has decreased because an action capability of the catalyst of the anode electrode has decreased (this happens when the catalyst is poisoned). Then, the volume of air bleed is increased to increase Capacitance C₁. The air bleed adds a minute amount of air to the fuel gas in order to oxidize and remove carbon monoxide that poisons the catalyst. If the combination (C₁, R₁) is in the area 111 even if the volume of the air bleed is increased, an alarm triggers off and the operation of the fuel cell is stopped because the catalyst of the anode electrode is too poor for it to be used.

Step 29 to 30 (S29-S30): In a case where the combination (C₁, R₁) is in the area 112 because of increasing Resistant R₁, it is judged that the catalyst of the anode electrode is completely dried out because there is excess fuel gas. Then, the ratio U_{f} of utilizing the fuel gas is decreased for the operation so that Resistant R₁ would be decreased.

Step 31 to 32 (S31-S32): To the contrary, if the combination (C₁, R₁) moves into the area 113 because of decreasing Resistant R₁, the ratio U_{f} of utilizing the fuel is increased to increase Resistant R₂.

Step 33 to 34 (S33-S34): In a case that the combination (C₁, R₁) is in the area 114 because of increasing Capacitance C₁, it is judged that the volume of the air bleed is excessive. Then, the volume of the air bleed is decreased to decrease Capacitance C₁.

After these steps as explained and shown are carried out, the process goes back to Step 2 in order to calculate the impedances again. As explained above, the area is defined based on the initial values and experimentation. Therefore, if the initial values are changed because of the changes in the constructions or the shapes of the fuel cell, it is preferable to shift the areas based on the new initial values.

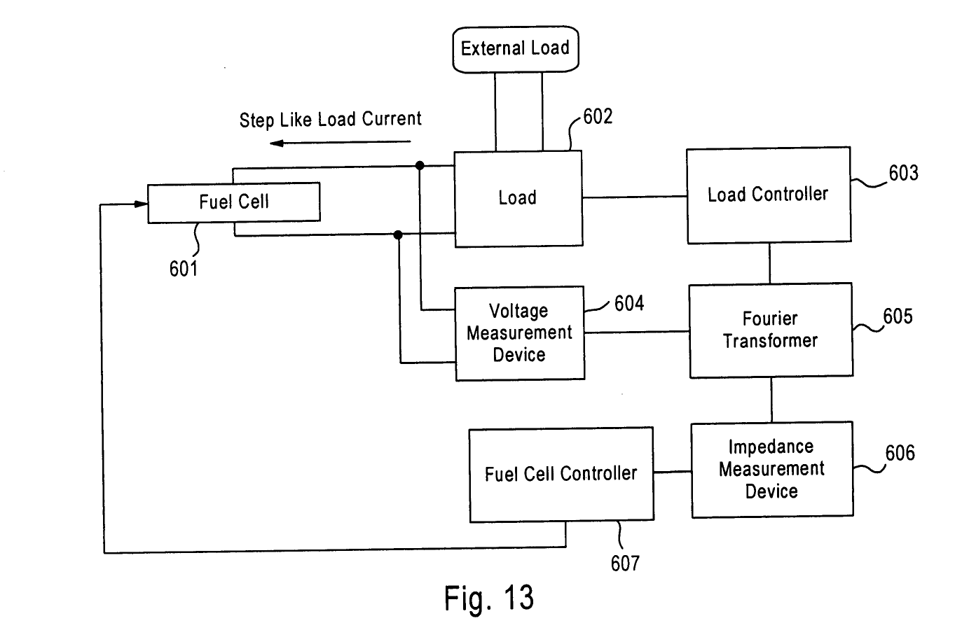

FIG. 13 shows a second embodiment of a fuel cell system, and the construction of this fuel cell system is explained hereinafter.

Since the construction of the fuel cell system of the second embodiment is similar to the construction of the fuel cell system of the first embodiment, the main differences between the first and the second embodiments are explained below. The fuel cell system of the second embodiment is a fuel cell system that generates electricity by providing an oxygen-based oxidizer to a cathode and providing a hydrogen-based fuel gas to an anode. The fuel cell system of the second embodiment has a load controller 603 that changes in the amount of the load electric current in a fuel cell 601, and a voltage measurement device 604 to measure the time delayed voltage of the fuel cell 601. The amount of time which passes after the changes in the load electric current and the digital data of the voltage at that time are transformed using a Fourier transformation, and the impedance measurement device 606 measures impedances of the fuel cell 601. The condition of the operation for the fuel cell is changed based on the impedances. How the fuel cell system of this embodiment operates is further explained below.

Since the second embodiment is similar to the first fuel cell system as explained above, the main differences are explained hereinafter. The fuel cell 601 is connected to the load 602 that is controlled by the load controller 603. The load electric current, amount of which is varied by a certain level each time, flows to the fuel cell 601. A range of fluctuations of the load electric current is within about 0 to about 200% of the regular power output of the fuel cell and the increased/decreased values of the load electric current is more than about 10% of the regular power output of the fuel cell. The voltage measurement device 604 measures the changes in the voltage of the fuel cell during the time when the load electric current is changed. The time past after the change of the load electric current and the digital data of the voltage of the fuel cell 601 at that time are transformed by Fourier's transformation of the Fourier's transformation part 605.

After transforming the voltage responses to the digital data at a certain frequency, the impedance measurement device 606 calculates the impedance, the fuel cell controller 607 controls the changes in the conditions for the operation for the fuel cell 601 based on the impedance. Although it is possible to change the load electric current to measure the impedance, it is preferable to measure the impedance when switching the fuel cell system on/off or increasing/decreasing the capability to generating electricity, which leads to changes in the load electric current.

The function of the Fourier transformation part 605 is explained in detail below. A time function to change the load electric current in steps is set as Iₛₜₑₚ(t), and a time function of the cell voltage at the timing is set as Eₛₜₑₚ(t) where “t” means time. The frequency functions after transformation of Iₛₜₑₚ(t) and Eₛₜₑₚ(t) by the Fourier's transformation are shown in Expression 32 where “f” is frequency.
FIₛₜₑₚ(f)=∫_{-∞}Iₛₜₑₚ(t)e^{-2πfjt}dt,
FEₛₜₑₚ(f)=∫_{-∞}^{∞}Eₛₜₑₚ(t)e^{-2πfjt}dt (Expression 32)

Therefore, the impedance Zₛₜₑₚ(f) is shown in Expression 33.
Zₛₜₑₚ(f)=FEₛₜₑₚ(f)/FIₛₜₑₚ(f) (Expression 33)

As such, the Fourier's transformation part 605 calculates the time functions Iₛₜₑₚ(t) and Eₛₜₑₚ(t) into the frequency functions FIₛₜₑₚ(f) and FEₛₜₑₚ(f).

Since the Fourier's transformation part 605 consists of a digital computer and so on, the time functions Iₛₜₑₚ(t) and Eₛₜₑₚ(t) are divided into a limited number of the time functions to be calculated so that a limited number of frequency functions FIₛₜₑₚ(f) and FEₛₜₑₚ(f), and impedances Zₛₜₑₚ(f) are calculated.

In one aspect of the present invention, the load 602 and the load controller 603 correspond to the changes in the load electric current, the impedance measurement part 606 corresponds to the measurement means, the fuel cell control part 607 corresponds to the fuel cell control mean and the fuel cell system of the second embodiment corresponds to the fuel cell system.

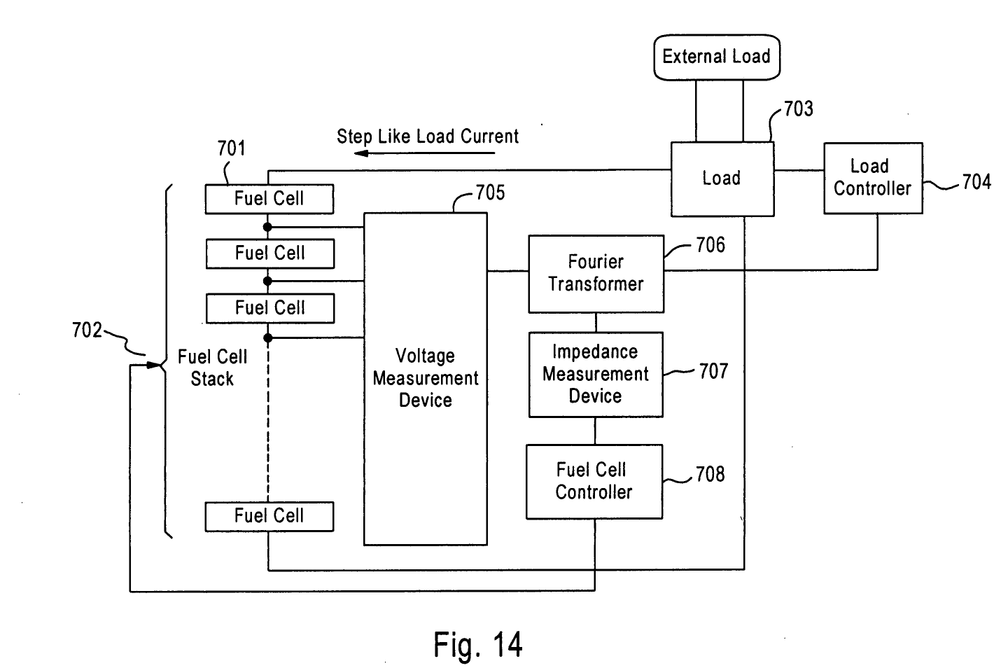

FIG. 14 shows a fuel cell system of a third embodiment of the present invention, the construction of which is explained hereinafter. The fuel cell system of the third embodiment has a fuel cell stack 702 composed of multiple fuel cells 701 connected in series where each fuel cell generates electricity by providing an oxygen-based oxidizer to its cathode electrode and a providing hydrogen-based fuel gas to its anode electrode. The fuel cell system has a load controller 704 that changes the load 703 which is also used for each fuel cell 701 and the voltage measurement device 705 that can measure the voltages of each fuel cells 701. The impedance measurement device 707 measures impedance of each fuel cell 701 and the conditions for the operations are changed based on the impedances. In the fuel cell system of this embodiment, the impedances of each of the fuel cells 701 composing the fuel cell stack 702 are separately measured. How the fuel cell system of this embodiment operates is further explained below.

The stack 702 comprising multiple fuel cells 701 piled on top of each other is connected to the load 703 which is controlled by the load controller 704, and the load electric current allows a certain amount of electricity to flow to the fuel stack 702. Each fuel cell 701 is connected to the voltage measurement device 705. The voltage measurement device 705 measures the changes in the voltages of each fuel cell 701 while the load electric current is being changed. The time which passed after the change in the load electric current and the digital data of the voltages of each fuel cell 701 at that time are transformed by Fourier's transformation by the Fourier's transformation device 706. After transforming the voltage responses to digital data at a certain frequency, the impedance measurement device 707 calculates the impedances, the fuel cell controller 708 controls the change in the conditions for the operation of each fuel cells 701 based on the impedances calculated. Although it is possible to change the load electric current to measure the impedances, it is preferred to measure the impedances when switching the fuel cell system on/off or increasing/decreasing the capability of electricity from generating, which leads to changes in the load electric current.

In one aspect of the present invention, the load 703 and the load controller 704 correspond to the load electric current changing means, the impedance measurement part 707 corresponds to the measurement means, the fuel cell control part 708 corresponds to the fuel cell control means and the fuel cell system of the second embodiment corresponds to the fuel cell system.

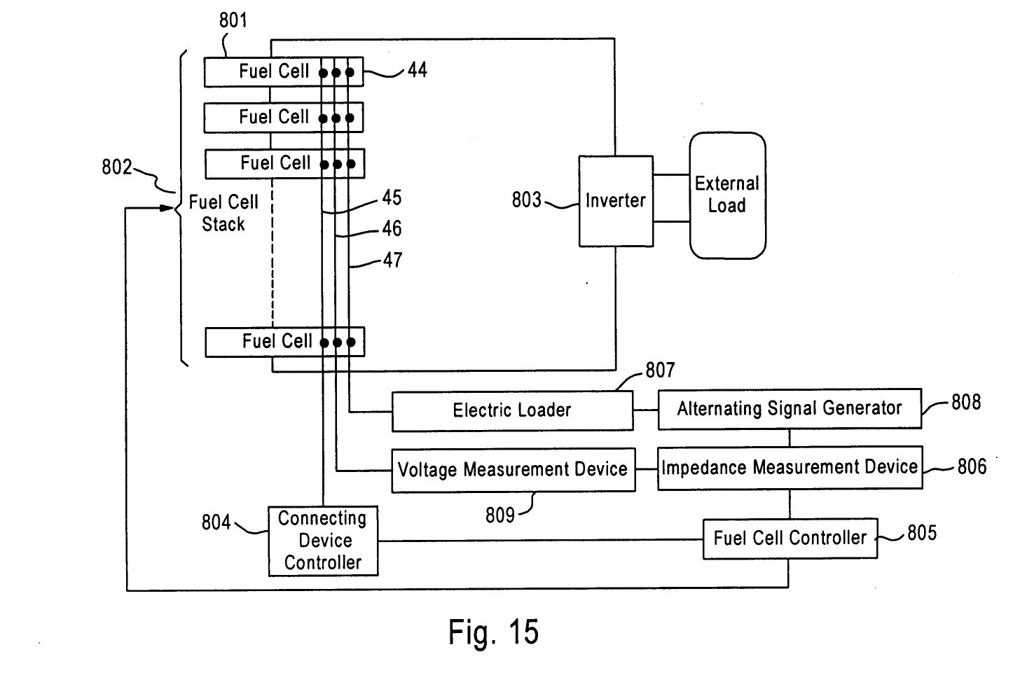

FIG. 15 shows a fuel cell system of a fourth embodiment, the construction of which is explained hereinafter.

As shown on the FIG. 15, the fuel system comprises the fuel cell stack 802 which is composed of multiple fuel cells 801 piled on top of each other which are connected to an inverter 803, which is then connected to the outer load. Each fuel cell 801 has an auto connecting device 44. Each auto connecting device 44 is connected to each connecting device control line 45, a voltage measurement line 46 and a current line 47 through terminals of the auto connecting device 44. How the fuel cell system of this embodiment operates is further explained below.

The terminals of the auto connecting devices 44 are turned off in a normal situation. Only when the terminal of the auto connecting device 44 receives an address signal through the connecting device control part 45, and the address signal received is identical to the address information of the auto connecting control device 44, that both voltage measurement line 46 and the current line 47 are connected to the fuel cell 801 through the auto connecting device 44.

Because of the simple design of the lines using only one voltage measurement line 46 and only one current line 47, it is easy to connect a fuel cell 801 and an impedance measurement device 806. A small current from the fuel cell 801 and the impedance measurement device 806 is extracted by the electric loader 807 and an alternating signal is overlapped on top of the small current by the alternating generator 808. The voltage measurement part 809 measures the changes in the voltage of the fuel cell 801 while the load electric current is changed. The impedance measurement device 806 calculates the impedance from the voltage reaction. The fuel cell control part 805 controls the conditions for the operation of the fuel cell 801 based to the value of the impedance.

In advance of operating the system in the field, impedances of each cell are measured under the normal conditions and values of each component of an equivalent circuit, as explained later, are calculated from the impedances measured. These values are included in the pre-calculated values. Then, these values as well as address information given to each auto connecting devices of fuel cells are noted.

Then, it is possible to understand the conditions of each cell during the operation in real time and control the operation of the fuel cells in the best way in the event of an abnormality by measuring the impedances of the cells, calculating the values of the each components of the equivalent circuit and comparing the values calculated with the values noted previously. Namely, the fuel cell system of this embodiment uses the auto connecting device 44 in each cell to send a specific address restriction signal to all cells, where only the targeted cell with the matching address connects to the impedance measuring device 806. This diagnoses the reasons behind the abnormality and allows the operator to take appropriate actions.

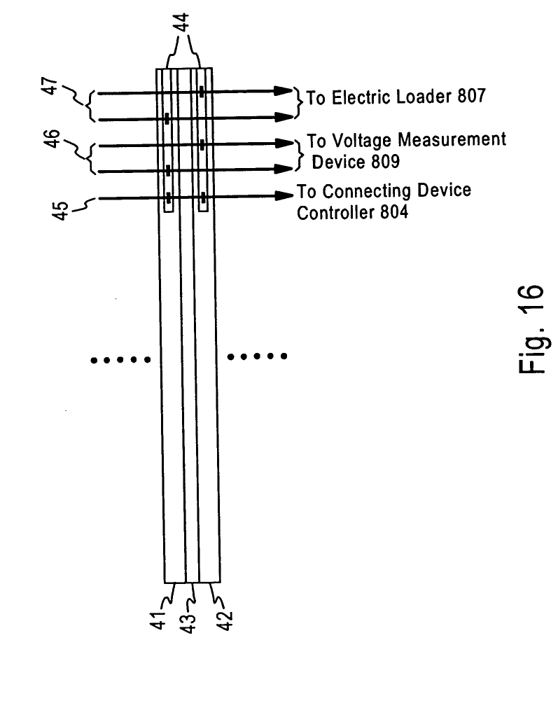

Below explains the connection between the auto connecting device 44 inside the separators and the impedance measuring device 806 by using FIG. 16 which contains a diagram of the auto connecting device 44.

The auto connecting device 44 has a specific address according to its cell, and receives a specific signal from the impedance measuring device 806. If the address sent from the impedance measuring device 806 and its own address match, it connects to the impedance measuring device 806, the electric loader 807, the alternating generator 808, and the voltage measuring device 809. Of course, if the addresses do not match, it is disconnected from the impedance measuring device 806, the electric loader 807, the alternating generator 808, and the voltage measuring device 809. Therefore, it is possible to only connect specific cells to the impedance measuring device 806, the electric loader 807, the alternating generator 808, and the voltage measuring device 809.

In one aspect of the present invention, the electric loader 807 and the alternating generator 808 correspond to the alternating electric loader means, the voltage measuring device 809 corresponds to the means for measuring, the impedance measuring device 806 corresponds to the calculating means, the fuel cell controller 805 corresponds to the means for controlling the fuel cell, and the fourth embodiment corresponds to the fuel cell system. Furthermore, the current line 47 corresponds to the first wire, the voltage measuring line 46 corresponds to the second wire, the auto connecting device 44 corresponds to the means for connecting different devices, and finally, the means which involve connecting device controller 804 and connecting device controller line 45 correspond to this embodiment's control for connecting and restricting individual devices. How the fuel cell system of this embodiment operates is further explained below.

Calculating impedance and the controls involved in determining the conditions for operation in a prescribed fuel cell system is further described below.

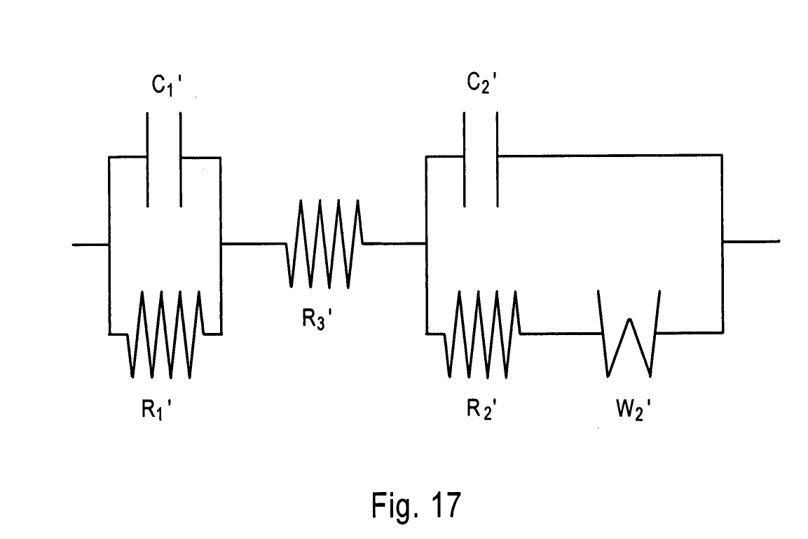

First, an equivalent circuit that shows the cell's impedance is explained by using FIG. 17, which contains an equivalent circuit with the cell's impedance. The cell's impedance includes the anode's impedance, the cathode's impedance, the electrolyte membrane's impedance, and the resistance created from connections. The changes in this impedance is shown in the equivalent circuit in FIG. 17. An alternating current of the frequency f′ having a small amount of amplitude which corresponds to less than about 10% of the direct current preferably extracted and overlapped on top of the direct current in order to calculate the impedance Z′ in a similar way to the first embodiment. The frequency of the load current is preferably swiped from 0.1 Hz to 1000 Hz, and the corresponding impedance Z′ is calculated. In this case, the impedance is preferably measured by changing some specific frequencies, and measured when there are multiple frequencies in the same current.

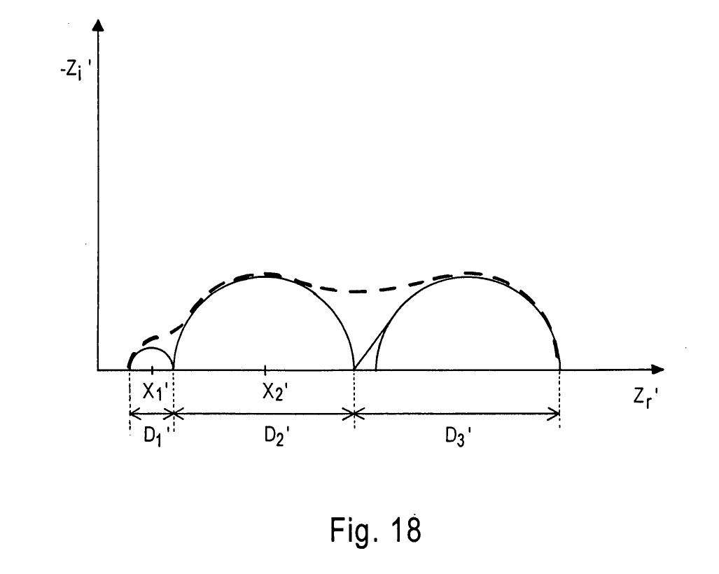

Furthermore, when Z is a complex impedance of an equivalent circuit, Zᵣ is its real part, and Zᵢ is its imaginary part with its sign reversed. Zr should be on the horizontal axis and Zᵢ should be on the imaginary axis in order to draw a cole-cole plot that is similar to FIG. 18, which illustrates a cole-cole plot.

As shown in FIG. 17, a cole-cole plot of an equivalent circuit that includes the combination of resistance and condenser (R₁′, C₁′), the combination of resistance, condenser, and Warlburg resistance (R₂′, C₂′, W₂′), as well as resistance R₃ results is a combination of two semi circles and a curve (corresponds to a cole-cole plot of the Warlburg resistance) which is a result of combining an arc and a straight line.

In FIG. 18, two semi circles and a curve including an arch and a line are shown in a real line, while the shape that is found by adding the dots is shown in a dotted line. Each arc's radius and center co-ordinates are determined in the ascending order of frequency. The first and the second semi circles have central coordinates X₁′ and X₂′, and diameters D₁′ and D₂′, and the curve which is formed as a result of adding an arch and a line would have a wideness of D₃′. Then, for each of the 2 semi circles and the curve, the point with the highest frequency within those curves is determined. They can be identified as f₁′, f₂′, and f₃′ in order. Then the following expression 34 is achieved.
C₁′=1/(2πf₁′R₁′)=1/(2πf₁′D₁′), C₁′=1/(2πf₂′R₂′)=1/(2πf₂′D₂′),
R₁′=D₁′, R₂′=D₂′, R₃′=X₁′−D₁′/2,
W₂′=W_{2R}′tan h(√(2πf₃′jW_{2T}′))/√(2πf₃′jW_{2T}′)=D₃′tan h(√(2πf₃′jW_{2T}′))/√(2πf₃′jW_{2T}′),
W_{2R}′=D₃′ (Expression 34)

Also, W_{2T}′ is a constant for determining the level of gas diffusion.

This is how each component of the equivalent circuit is calculated to match the shapes drawn in the figures. Then, the changes in each component's values in the equivalent circuit is measured by changing the conditions of the operation of the cell. Then, C₁′ and R₁′ change the most when changing the boiling point of the fuel gas. It was also found that C₂′ and R₂′ change the most when changing the boiling point of the oxygen based gas, and W_{2R}′ change the most when changing the oxygen utilizing ratio of the oxygen-based gas.

From above, it was observed that C₁′ corresponds to the anode's dual electricity volume, R₁′ corresponds to the anode's response resistance, C₂‘corresponds to the cathode’s dual electricity volume, R₂‘corresponds to the cathode’s response resistance, and W_{2R}′ corresponds to the cathode's diffusion resistance. Furthermore, it was discovered that increasing the wetness results in a decrease in R₃′. Therefore, R₃′ corresponds to a resistance of a high molecule membrane. Thus, measuring the changes in C₁′ indicates abnormality and degeneration of the anode electrode catalyst's reaction area.

It was further observed and determined that measuring the changes in R₁′ shows abnormality and degeneration of the anode electrode catalyst's reaction resistance. Measuring the changes in C₂′ shows abnormality and degeneration of the cathode electrode catalyst's reaction resistance. Measuring the changes in R₂′ shows abnormality and degeneration of the cathode electrode catalyst's reaction resistance. Measuring the changes in W_{2R}′ shows abnormality and degeneration of cathode's gas diffusion layer's diffusion resistance. Measuring the changes in R₃′ shows abnormality and degeneration of high molecule membrane's wetness level.

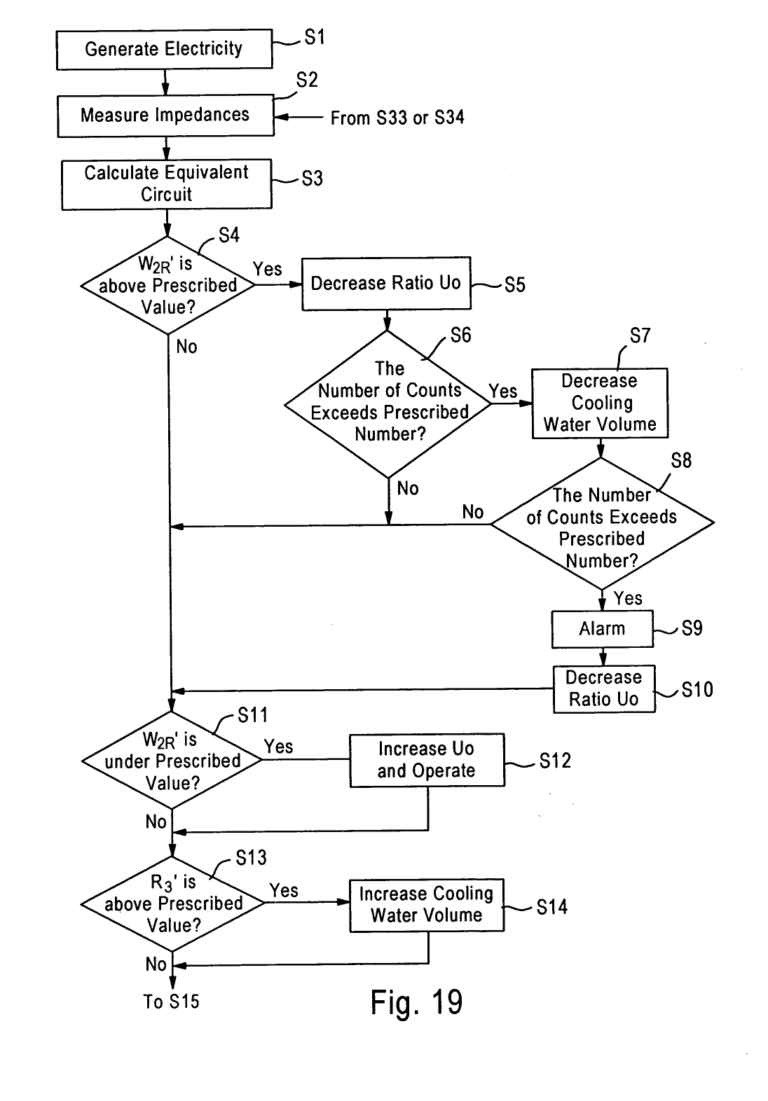

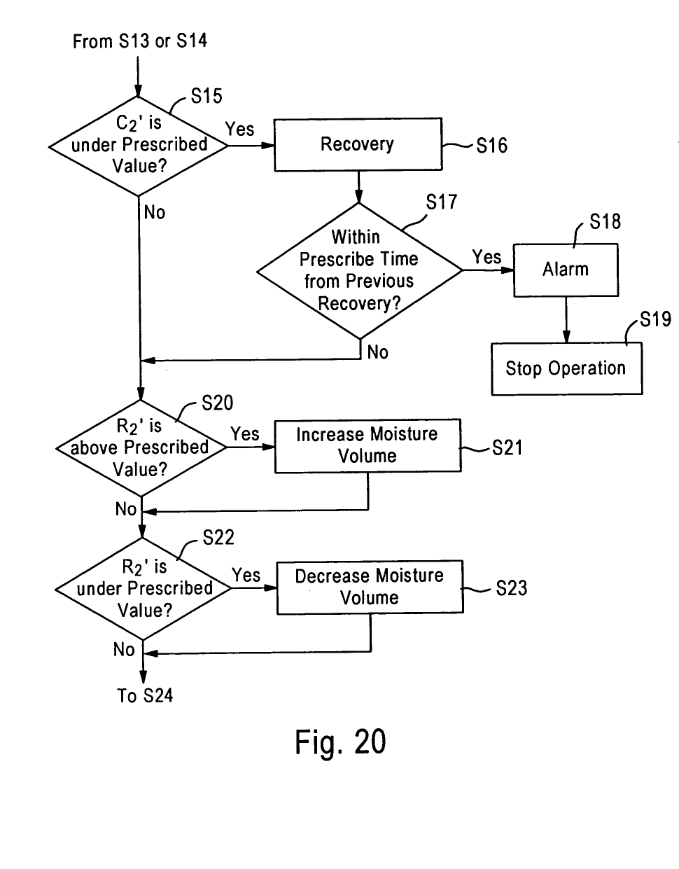

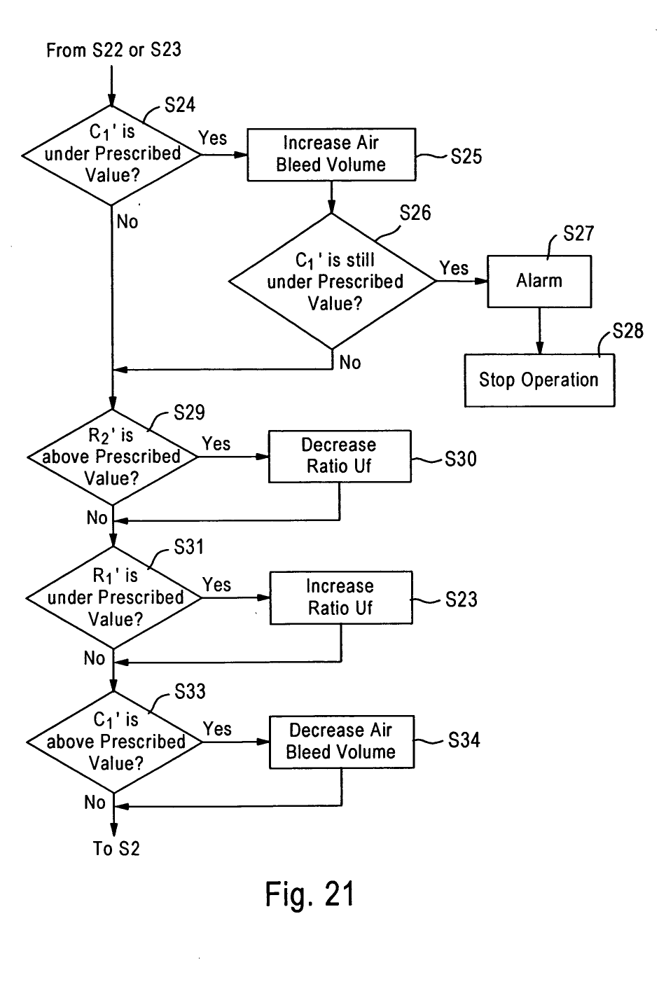

The following explains the controls for the system in detail with reference to FIG. 19, FIG. 20 and FIG. 21 (flow charts for explaining the system controls).

Step 1 to 3 (S1-S3): After generating electricity has started, the impedance needs is preferably measured constantly. However, the order of the cell in which the impedance is measured does not matter—it can be in the alphabetical order of the address or just randomly. Each component's value is determined from the measured impedances. Then, judgment is done on W₂′ of the equivalent circuit. W₂′ is a component related to the cathode's gas diffusion; however, W_{2R}′ shows the amount of gas diffusion resistance.

Step 4 to 10 (S4-S10): Increase in W_{2R}′ indicates a decrease in the gas diffusion rate due to an increase in the wetness. Therefore, when the value of W_{2R}′ is above a prescribed value, the ratio U₀′ of utilizing air is reduced for a certain amount of time to increase the flow of gas to dry some of the wet area. The number of the times the ratio U₀′ of utilizing air was reduced is also counted Then, if such operations must be repeated and the number of the times the ratio U₀′ of utilizing air was reduced goes beyond the predefined constant, the amount of cooling water must be reduced for a certain time in order to diagnose the wetness problem. The number of times the amount of cooling water had to be reduced is also counted. Then, if such operations must be repeated and the number of the times the amount of cooling water had to be reduced goes beyond a predefined constant, it is judged that the electrode's material itself must have degenerated and has become easily wetted. Then, Trigger off the alarm and lower the ratio U₀′ of utilizing air, and continue the operation.

The alarm is used to notify the user of the abnormality, and to inform the user of the necessity of maintenance. Also, the alarm is useful in diagnosing the problem during the maintenance operation.

Step 11 to 12 (S11-S12): Decrease in W_{2R}′ indicates an increase in dryness. Therefore, the ratio U₀′ must be increased to prevent it from drying further (alternatively, the amount of gas can be reduced). From here on, judgment on R₃′ is made. R₃′ shows the size of the high molecule membrane's resistance.

Step 13 to 14 (S13-S14): Increase in R₃′ indicates an increase in the resistance of the high molecule membrane due to dryness. Therefore, the amount of cooling water must be increased in order to create an environment where it is easy to become wet. From here on, judgment on R₂′ and C₂′ is made by referring to FIG. 20. R₂′ refers to the reaction resistance in the cathode's catalyst layer, and C₂′ is the reaction area in the cathode's catalyst layer.

Step 15 to 19 (S15-S19): Decrease in C₂′, which leads to the reactivity of the electrode's catalyst, indicates a decrease in the electrode's appearance area. Therefore, when C₂′ is below a predefined value, recovery motion is triggered. Recovery involves allowing the load current to flow by shutting the air and allowing the fuel gas to flow, or using un-reactive gas instead of air to lower the cathode's electron level (lower the cell voltage). This will recover the electrode catalysts that have low reactivity due to excessive oxidization and dust or any other unwanted pieces that the catalysts have attracted. However the catalyst itself is likely to be unusable if the reaction area does not increase after the recovery, or if the reaction area decreases immediately after the previous recovery. In such an event, an alarm should be triggered off and the operation should stop.

Step 20 to 21 (S20-S21): Increase in R₂′ indicates that it is less reactive due to dryness of the catalysts. Therefore, when R₂′ is above a predefined value, an increase in the wetness in the air should be undertaken.

Step 22 to 23 (S22-S23): On the contrary, a decrease in R₂′ indicates excessive wetness of the catalysts, and the wetness in the air should be decreased. The below judges R₁′ and C₁′ based on FIG. 21. R₁′ refers to the reaction resistance of the catalyst and C₁′ refers to the reaction area of the anode's catalyst.

Step 24 to 28 (S24-S28): A decrease in C₁′ leads to a decrease in reactivity of the anode electrode and cathode due to poisoning, and this indicates a decrease in the electrode area. Therefore, when C₁′ is below a predefined value, the amount of air bleed should be increased. Air bleed is a method for oxidizing and removing carbon monoxide from the surface of the catalyst by adding a small amount of air to the fuel gas. If C₁′ is lower that the predefined value even if increasing the amount of air bleed has been increased, the anode electrode's catalyst must have degenerated too much. Therefore, an alarm should be triggered off and the operation should be stopped.

Step 29 to 30 (S29-S30): An increase in R₁′ indicates a decrease in reactivity due to dryness of the anode caused by excessive amounts of fuel gas. In this case, lower the fuel's utilizing ratio U_{f}, and continue operation (alternative is to increase the wetness of the fuel gas).

Step 31 to 32 (S31-S32): On the contrary, a decrease in R₁′ indicates an excessive wetness of the catalyst. In this case, increase U_{f}, and continue operation (alternative is to decrease the wetness of the fuel gas).

Step 33 to 34 (S33-S34): An increase in C₁′ indicates an excessive amount of air bleed. In this case, reduce the amount of air bleed. Furthermore, the above predefined values should be set so that normal operation can be carried out by the control. After a judgement on the specific cell's usability is made, the connecting device controller 804 can send the signals to the next targeted cell. Then, if the address signal and the auto connecting device's 44 address match, that cell's impedance is measured and controlled in the same way as before. Therefore, after measuring one cell, it changes the address signal, and repeats the process until all cells in the fuel cell stack 802 are taken care of. Then, the process repeats itself again. This system allows an auto check-up to be carried out by using an inexpensive and easy wiring, and makes it easy to detect problems, diagnose the reasons behind the abnormality, and carry out appropriate actions so as to efficiently and reliably operate a fuel cell system.

### EXAMPLES

The following examples describe arrangements and operation of fuel cell systems in accordance with certain embodiments of the present invention in more detail. These examples are intended to further illustrate certain preferred embodiments of the invention and are not limiting in nature. Those skilled in the art will recognize, or be able to ascertain, using no more than routine experimentation, numerous equivalents to the specific arrangements and procedures described herein.

### Example 1

The makings of the fuel cell electricity generating system in the Example 1:

First, a gas diffusion layer was created as follows: Immerse about 10 weight % of diffusive solution of Polytetrafluoroetheylene (Daikin Kogyou Lubron LDW-40) as dry weight on a carbon paper (Toure TGPH-060). Then, use a hot-air dryer to heat the paper to about 350° C. to dry the paper. Then, high ion molecule conductive layer was created from carbon powder and fluoride resin. In particular, prepare a dispersion liquid which is created from Denkablack of Denki Kagaku Kogyou as carbon powder with about 30 weight % of Polytetrafluoroethylene dispersion liquid (Daikin Kogyou Rubron LDW-40) as dry weight as the fluorine resin. Then, paint the prepared dispersion liquid on the dried carbon paper as previously described, and create a gas diffusion layer including a conductive layer containing a polymer by drying the dispersion liquid at about 350° C. by a hot-air dryer.

Then, a membrane-electrode assembly (MEA) was created as follows. Prepare a conductive carbon powder with about 50 weight % of platinum grains with average powder size about 30Á (Tanaka Kinzoku Kougyo TEC10E50E). Add about 10 grams of water to about 10 grams of such powder. In addition, add about 55 grams of ethanol solution with about 9 weight % of hydrogen ion conductive polymer electrolyte (Asahi Glass Flemion) so that a catalyst-paste is created. Place the paste on top of a polypropylene film by a bar-coating using wire bars. Dry the paste to create an catalyst layer for an electrode in a oxidizing side (i.e. a cathode). The amount of the paste should be around 0.3 mg of platinum per 1 cm². Add about 10 grams of water to about 10 grams of conductive carbon powder with a platinum-ruthenium alloy (Tanaka Kinzoku Kougyo TEC61E54), and then mix about 9% ethanol solution containing about 50 grams of hydrogen ion conductive polymer electrolyte (Asahi Glass Flemion) to create a catalyst-paste. Place the catalyst-paste on top of a polypropylene film by bar-coating using wire bars. Dry the firm to create a catalyst layer for an electrode in a fuel side (i.e. an anode). The amount of paste should be around 0.3 mg of platinum per 1 cm². Cut these polypropylene films in squares with sides of about 6 cm. Then put the two sets of polypropylene films (with the catalyst side inside) on either side of the hydrogen ion conductive polymer electrolyte membrane. Then, hot press the membrane for about 10 minutes at about 130° C., and remove the film to create a polymer electrolyte membrane with catalysts layers. On both side of the membrane, add gas diffusion layers so that the polymer conductive layer is in the middle. This is an example of how an MEA can be created. In addition, separating plates were created by making gas channels and cooling water channels on a graphite plate.

A fuel cell is created by sandwiching a separating plate by a pair of MEA. By using this fuel cell, a fuel cell system of the first embodiment of this invention is composed.

Operating the fuel cell system in Example 1:

On the fuel electrode side, supply a mixed gas (hydrogen 80%, carbon dioxide 20%, carbon monoxide 20 ppm) and air (amount of which is 1% of the volume of the mixed gas) as an air bleed. Add it with some humidity so that its dew point is about 70° C. On the oxidizing electrode side, supply air with some humidity so that its dew point is about 70° C. Electricity was generated under a condition where the fuel utilizing ratio was about 80%, air utilizing ratio was about 40% and a current density was about 200 mA/cm². Temperature of the cooling water was 70° C. at the entrance of the fuel cell 501, and between about 72-75° C. at exit. The voltage on the fuel cell 501 was about 0.75V.

Control of the operation for the fuel cell system in this Example 1: The alternating signals generator 503 generated alternating signals at 1 Hz, 2 Hz, 4 Hz, 8 Hz, 16 Hz, 32 Hz, 64 Hz, 128 Hz, and 256 Hz in this order, and controlled the load electric current at the timings which synchronize the frequencies of the alternating signals. The load electric current was a current where 200 mA/cm² of direct current was overlapped on top of ±10 mA/cm² of sine wave. The voltage changes at that moment is measured by voltage measurement device 504, and impedance was found by impedance measuring device 505. The system was controlled in accordance with the flow charts as shown on FIGS. 7 to 9.

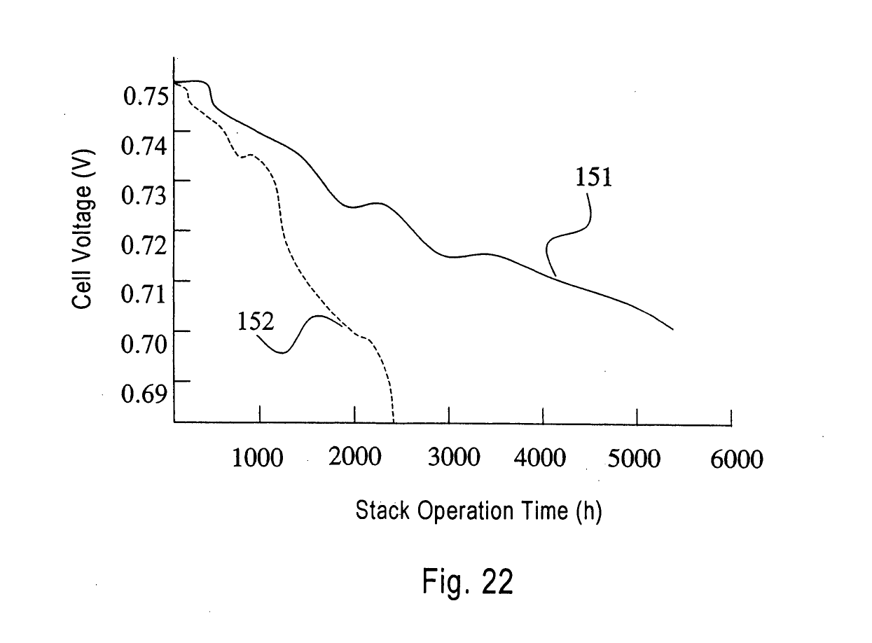

FIG. 22 shows the fuel cell according to this example's changes in voltage at different times as well as a comparison the sample's voltage changes. Cell voltage 151 is used to show the changes in voltage. Even after 5000 hours from initially operating the system, the cell voltage 151 held at more than 0.70V. The cell voltage line 152 shows the operation of a fuel cell system without the benefit of the present invention as explained further below.

### Example 2

Fuel cells were created similar to Example 1, which were used to produce a fuel cell electricity generating system by using the same steps as Example 1. The same operations were carried out and the controls used were the same as FIGS. 7 to 9. However, in this example, the step of decreasing U_{f} (S30) and the step of increasing step U_{f} (S32) in FIG. 9 were not carried out.

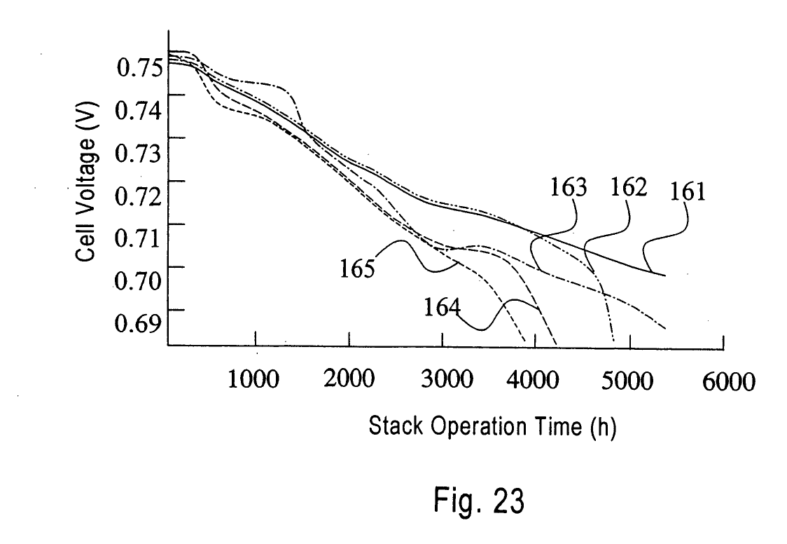

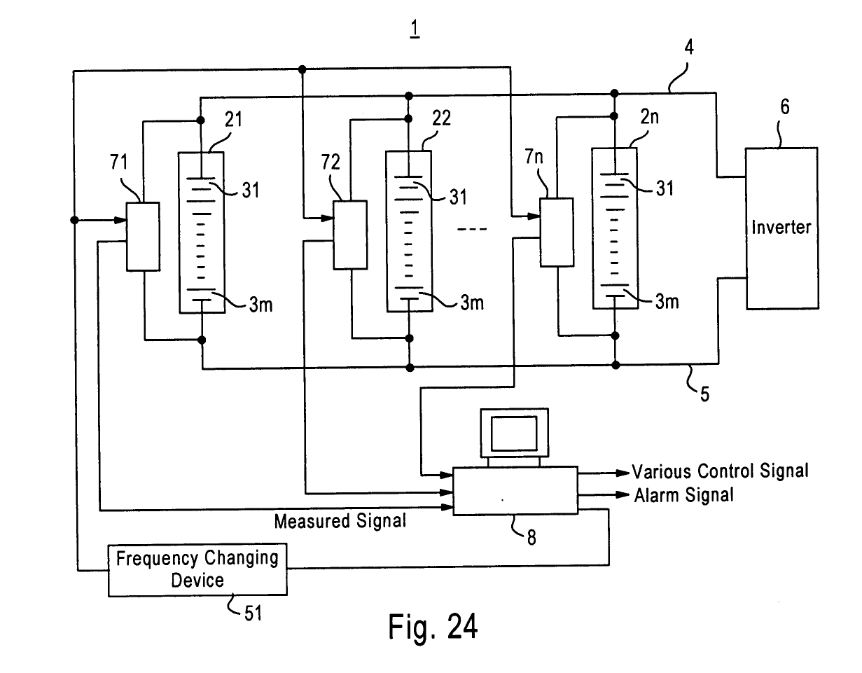

FIG. 23 shows the cell voltage changes at different times of examples 2 to 6, and the one for example 2 is indicated by cell voltage 161. Even after 5000 hours from initially operating the system, the cell voltage 161 held at more than 0.70V.

### Example 3

Fuel cells were created similar to Example 1, which were used to produce a fuel cell electricity generating system of the first embodiment by using the same steps as Example 1. The same operations were carried out and the controls used were the same as FIGS. 7 to 9. However, in this example, the step of increasing the amount of air bleed (S25) and the step of increasing the amount of air bleed (S34) were ignored.

FIG. 23 shows a line 162 as the changes of the cell voltage of Example 3 as time passed. Even after 4500 hours from initially operating the system, the cell voltage 162 held at more than 0.70V.

### Example 4

Fuel cells were created similar to Example 1, which were used to produce a fuel cell electricity generating system by using the same steps as Example 1. The same operations were carried out and the controls used were the same as FIGS. 7 to 9. However, in this example, the step for increasing the amount of wetness in the air (S21) and the step for decreasing the same (S23) were ignored.

FIG. 23 shows the changes of the cell voltages as time passed. The line 163 shows the case of this Example 4. Even after 4000 hours from initially operating the system, the cell voltage 163 held at more than 0.70V.

### Example 5

Fuel cells were created similar to Example 1, which were used to produce a fuel cell electricity generating system by using the same steps as Example 1. The same operations were carried out and the controls used were the same as FIGS. 7 to 9. However, in this example, the step for decreasing the amount of cooling water (S12) and the step for increasing the same (S14) in FIG. 7 were ignored.

FIG. 23 shows the changes of the cell voltages as time passed. The line 164 shows the case of this Example 5. Even after 3500 hours from initially operating the system, the cell voltage 164 held at more than 0.70V.

### Example 6

Fuel cells were created similar to Example 1, which were used to produce a fuel cell electricity generating system by using the same steps as Example 1. The same operations were carried out and the controls used were the same as FIGS. 7 to 9. However, in this example, the steps for decreasing U₀ (S5 and S8) and the step for decreasing U₀ (S10) in FIG. 7 were ignored.

FIG. 23 shows the changes of the cell voltages as time passed. The line 165 shows the case of this Example 6. Even after 3000 hours from initially operating the system, the cell voltage 165 held at more than 0.70V.

### Example 7

Creation of the fuel cell system: Similar to Example 1, fuel cells were created by using the same steps of Example 1, which were then used to create a fuel cell electricity generating system in accordance with the second embodiment of the present invention.

Beginning of the operation: Providing moist hydrogen gas having a dew point of about 70° C. to the fuel electrode side and moist air having a dew point about 70° C. to the oxidizing electrode side, generating electricity was done under conditions such that the fuel utilizing ratio was about 80%, air utilizing ratio was about 40%, and current density was about 200 mA/cm². Temperature of cooling water was about 70° C. at entrance of the fuel cell 501, and between about 72-75° C. at exit.

Control of the operation: Every night, current density was reduced to about 100 mA/cm² for 2 hours, and the current density was set to zero immediately thereafter to cool off the fuel cell 601. Then, the system was stopped. In the morning, after running the system with current density at about 100 mA/cm² for an hour, the rest of the operation was carried out at about 200 mA/cm². In order to change the current density, the load controller 603 sends a control signal to change the load 602's load electric current in the shape of steps. At this moment, the changes in the voltage are measured by the voltage measurement device 604, which is then digitalized and transformed by Fourier transformation at Fourier transformation device 605. Impedance measuring device 606 was used to find the impedance, and the control was carried out by following the flow charts in FIGS. 7-9.

Similarly to Example 1, even after 5000 hours from initially operating the system, the cell voltage 165 held at more than 0.70V.

### Example 8

Creation of the fuel cell system: Similarly to Example 1, fuel cells were made and 60 of these cells were piled on top of each other to create a fuel cell stack. A fuel cell system in accordance with the third embodiment of the present invention was made from these stacks.

Beginning of the operation: A line lead from each fuel cell 701's separator plate was connected to the voltage measurement device 705. Providing moist hydrogen gas having dew point about 70° C. to the fuel electrode side and moist air having a dew point about 70° C. to the oxidizing electrode side, generating electricity was done under the condition such that the fuel utilizing ratio was about 80%, air utilizing ratio was about 40%, and current density was about 200 mA/cm². Temperature of cooling water was about 70° C. at entrance of the fuel cell 501, and between about 72˜75° C. at exit.

Control for the operation: Similarly to Example 7, current density was changed throughout the operation. The impedance was calculated at every instance, and control was carried out by following the flow charts in FIGS. 7-9.

Similarly to Example 1, even after 5000 hours from initially operating the system, the cell voltage held at more than 0.70V.

### Comparison Example

Creation of the fuel cell system: A fuel cell system for a comparison example was created so that it has the same structure as Example 1.

Beginning of the operation: Similarly to Example 1, providing moist hydrogen gas having a dew point about 70° C. to the fuel electrode side and moist air having a dew point about 70° C. to the oxidizing electrode side, generating electricity was done under the condition such that the fuel utilizing ratio was about 80%, air utilizing ratio was about 40%, and current density was about 200 mA/cm².

Control for the operation: The operation was done under the condition that current density was not changed at all, and impedance was not measured.

FIG. 22 shows the changes of cell voltage 152 of this example. After 20000 hours of operation, cell voltage 152 decreased to below 0.70V, and after another 2500 hours, electricity generating voltage decreased dramatically, and the system stopped operating.

Comparing Examples 1 to 8 with the comparison example, it is clear that this invention not only provides a better understanding of the state of fuel cells during operation, but facilitates easier maintenance, and optimum conditions for operating the fuel cells. This is shown by the long length of high level of voltages maintained throughout operation.

Furthermore, a program of this invention is a program to execute a part of or all parts of the steps in the operation method for a fuel cell system of this invention. A computer is preferably used to execute this program. A recording medium is a medium having the program to permit a computer to execute a part or all parts of the steps in the operation method for a fuel cell system of this invention. The program on the medium is able to be read by a computer and read by the computer to execute the steps.

As used herein a part of an operation is defined to be one or more steps in the numerous steps of the method. The steps for operation or movement means a part of or all of the steps for the operation or the movements which can be carry out. One example of utilizing the computer programs of this invention could be made so that a computer can read data from and write to the recording medium, and work well together with the computer.

Another example of utilizing the computer program can send data through transmitting devices, which are then read by the computer. In one aspect of the present invention, the recording medium includes ROM, and transmitting devices including elements such as the Internet, light, electricity waves and sound waves.

In addition, the computer can include hardware such as a CPU, and can include firmware, an operating system, and any other device typically employed in operating a computer or its equivalent. Therefore, as explained above, this invention can be implemented by software or by hardware.

The fuel cell system, operation method for the same, operation program for the same and recording medium for the program are highly reliable and useful for detecting, diagnosing, and resolving abnormalities during the operation of a fuel cell.

Only the preferred embodiment of the present invention and examples of its versatility are shown and described in the present disclosure. It is to be understood that the present invention is capable of use in various other combinations and environments and is capable of changes or modifications within the scope of the inventive concept as expressed herein. Thus, for example, those skilled in the art will recognize, or be able to ascertain, using no more than routine experimentation, numerous equivalents to the specific substances, procedures and arrangements described herein. Such equivalents are considered to be within the scope of this invention, and are covered by the following claims.

1. A fuel cell system comprising:
a load electric current changing means for changing an amount of load electric current that runs in one ore more fuel cells which are operated to generate electricity,
a measurement means for measuring voltage responses to the change in said load electric current,
a calculating means for calculating impedance of said one or more fuel cells based on said voltage responses measured, and
a fuel cell control means for controlling condition for operation of said one or more fuel cells by utilizing calculation results retrieved by said calculating means.

2. The fuel cell system according to claim 1, wherein said calculation uses Capacitance C₁, Resistance R₁, Capacitance C₂, Resistance R₂, Capacitance C₃ and Resistance R₃, in a case of said fuel cell's equivalent circuit consisting of a series circuit of (1) a resistor having Resistance R_{S}, (2) a parallel circuit of a capacitor having Capacitance C₁ and a resistor having Resistance R₁ corresponding to the reaction impedance of an anode of the fuel cell, (3) a parallel circuit of a capacitor having Capacitance C₂ and a resistor having Resistance R₂ corresponding to the reaction impedance of a cathode of the fuel cell and (4) a capacitor having Capacitance C₃ and a resistor having Resistance R₃ that are connected in parallel.

3. The fuel cell system according to claim 2, wherein a volume of air bleed in said fuel gas provided to said fuel cell is increased if a combination (C₁, R₁) of Capacitance C₁ and Resistance R₁ is within a domain defined by Expression 1 using constants a₁^{(L)} and b₁^{(L)} on the plane with Capacitance C₁ on the horizontal axis and Resistance R₁ on the vertical axis wherein C₁≦a₁^{(L)}R₁+b₁^{(L)} (Expression 1).

4. The fuel cell system according to claim 3, wherein an alarm triggers off and said operation is stopped if the combination (C1, R1) is within a prescribed domain even if volume of air bleed is increased.

5. The fuel cell system according to claim 2, wherein volume of air bleed in fuel gas provided to said fuel cell is decreased if the combination (C₁, R₁) of Capacitance C₁ and Resistance R₁ is within a domain defined by Expression 2 using constants a₁^{(U)} and b₁^{(U)} on the plane with Capacitance C₁ on the horizontal axis and Resistance R₁ on the vertical axis wherein a₁^{(U)}R₁+b₁^{(U)}≦C₁ (Expression 2).

6. The fuel cell system according to claim 2, wherein a utilizing ratio of fuel gas provided to said fuel cell is increased if a combination (C₁, R₁) of Capacitance C₁ and Resistance R₁ is within a domain defined by the Expression 3 using constants c₁^{(L)} and d₁^{(L)} on the plane with Capacitance C₁ on the horizontal axis and Resistance R₁ on the vertical axis wherein R₁≦c₁^{(L)}C₁+d₁^{(L)} (Expression 3).

7. The fuel cell system according to claim 6, wherein the domain is defined by the Expression 4 using not only said constants c₁^{(L)} and d₁^{(L)} but also constants a₁^{(L)}, b₁^{(L)}, a₁^{(U)} and b₁^{(U)}, wherein R₁≦c₁^{(L)}C₁+d₁^{(L)} and a₁^{(L)}R₁+b₁^{(L)}≦C₁≦a₁^{(U)}R₁+b₁^{(U)} (Expression 4).

8. The fuel cell system according to claim 2, wherein a utilizing ratio of fuel gas provided to said fuel cell is decreased if a combination (C₁, R₁) of Capacitance C₁ and Resistance R₁ is within a domain defined by Expression 5 using constants c₁^{(U)} and d₁^{(U)} on the plane with Capacitance C₁ on the horizontal axis and Resistance R₁ on the vertical axis wherein c₁^{(U)}C₁+d₁^{(U)}≦R₁ (Expression 5).

9. The fuel cell system according to claim 8, wherein said domain is defined by Expression 6 using not only said constants c₁^{(U)} and d₁^{(U)} but also constants a₁^{(L)}, b₁^{(L)}, a₁^{(U)} and b₁^{(U)} and wherein c₁^{(U)}C₁+d₁^{(U)}≦R₁ and wherein a₁^{(L)}R₁+b₁^{(L)}≦C₁≦a₁^{(U)}R₁+b₁^{(U)} (Expression 6).

10. The fuel cell system according to claim 2, wherein a cathode electrode of said fuel cell is recovered if a combination (C₂, R₂) of Capacitance C₂ and Resistance R₂ is within a domain defined by Expression 7 using constants a₂^{(L)} and b₂^{(L)} on the plane with Capacitance C₂ on the horizontal axis and Resistance R₂₁ on the vertical axis and wherein C₂≦a₂^{(L)}R₂+b₂^{(L)} (Expression 7).

11. The fuel cell system according to claim 10, wherein an alarm triggers off and said operation is stopped if said combination (C2, R2) is within said domain even if a prescribed time passes after performance of prescribed recovery.

12. The fuel cell system according to claim 2, wherein volume of humidification in oxidizer gas provided to said fuel cell is decreased when a combination (C₂, R₂) of Capacitance C₂ and Resistance R₂ is within a domain defined by Expression 8 using constants c₂^{(L)} and d₂^{(L)} on the plane with Capacitance C₂ on the horizontal axis and Resistance R₂₁ on the vertical axis and wherein R₂≦c₂^{(L)}C₂+d₂^{(L)} (Expression 8).

13. The fuel cell system corresponding to claim 12, wherein said domain is defined by Expression 9 using not only said constants c₂^{(L)} and d₂^{(L)} but also constants a₂^{(L)} and b₂^{(L)} and wherein R₂≦c₂^{(L)}C₂+d₂^{(L)} and wherein a₂^{(L)}R₂+b₂^{(L)}≦C₂ (Expression 9).

14. The fuel cell system corresponding to claim 2, wherein volume of humidification in oxidizer gas provided to said fuel cell is increased in a case when a combination (C₂, R₂) of Capacitance C₂ and Resistance R₂ is within a domain defined by Expression 10 using constants c₂^{(U)} and d₂^{(U)} and wherein c₂^{(U)}C₂+d₂^{(U)}≦R₂ (Expression 10).

15. The fuel cell system according to claim 4, wherein said domain is defined by Expression 11 using not only said constants c₂^{(U)} and d₂^{(U)} but also constants a₂^{(L)} and b₂^{(L)} and wherein C₂^{(U)}C₂+d₂^{(U)}≦R₂ and wherein A₂^{(L)}R₂+b₂^{(L)}≦C₂ (Expression 11).

16. The fuel cell system according to claim 2, wherein volume of cooling water provided to said fuel cell is decreased when a combination (C₃, R₃) of Capacitance C₃ and Resistance R₃ is within a domain defined by Expression 12 using constants a₃^{(L)} and b₃^{(L)} and wherein C₃≦a₃^{(L)}R₃+b₃^{(L)} (Expression 12).

17. The fuel cell system according to claim 16, wherein said domain is defined by Expression 13 using not only said constants a₃^{(L)} and b₃^{(L)} but also constants c₃^{(L)}, d₃^{(L)}, c₃^{(U)} and d₃^{(U)} and wherein C₃≦a₃^{(L)}R₃+b₃^{(L)} and wherein a₃^{(L)}C₃+d₃^{(L)}≦R₃≦c₃^{(U)}C₃+d₃^{(U)} (Expression 13).

18. The fuel cell system according to claim 2, wherein volume of cooling water provided to said fuel cell is increased if a combination (C₃, R₃) of Capacitance C₃ and Resistance R₃ is within a domain defined by Expression 14 using constants a₃^{(U)} and b₃^{(U)} and wherein a₃^{(U)}R₃+b₃^{(U)}≦C₃ (Expression 14).

19. The fuel cell system according to claim 18, wherein said domain is defined by Expression 15 using not only said constants a₃^{(U)} and b₃^{(U)} but also constants c₃^{(L)}, d₃^{(L)}, c₃^{(U)} and d₃^{(U)} and wherein a₃^{(U)}R₃+b₃^{(U)}≦C₃ and wherein c₃^{(L)}C₃+d₃^{(L)}≦R₃≦c₃^{(U)}C₃+d₃^{(U)} (Expression 15).

20. The fuel cell system according to claim 2, wherein a utilizing ratio of oxidizer gas provided to said fuel cell is increased if a combination (C₃, R₃) of Capacitance C₃ and Resistance R₃ is within a domain defined by Expression 16 using constants c₃^{(L)} and d₃^{(L)} on the plane coordinates having the horizontal axis in relation to Capacitance C₃ and the vertical axis in relation to Resistance R₃ and wherein R₃≦c₃^{(L)}C₃+d₃^{(L)} (Expression 16).

21. The fuel cell system according to claim 2, wherein a utilizing ratio of oxidizer gas provided to said fuel cell is decreased if a combination (C₃, R₃) of Capacitance C₃ and Resistance R₃ is within a domain defined by Expression 17 using a constant c₃^{(U)} and a constant d₃^{(U)} on the plane with Capacitance C₃ on the horizontal axis and Resistance R₃ on the vertical axis and wherein C₃^{(U)}C₃+d₃^{(U)}≦R₃ (Expression 17).

22. The fuel cell system according to claim 21, wherein an alarm triggers off and said operation of said fuel cell is continued with a decreased utilizing ratio of oxidizer gas if said utilizing ratio of oxidizer gas is decreased for more than a prescribed time.

23. The fuel cell system according to claim 1, wherein an impedance of said fuel cell is calculated by using Capacitance C₁′, Resistance R₁′, Capacitance C₂′, Resistance R₂′, Resistance W_{2R}′ and Resistance R₃′ in a case of said fuel cell's equivalent circuit consisting of a series circuit of (1) a parallel circuit of capacitor with Capacitance C₁′ corresponding to a capacitance of electric dual layers of an anode and a resistor having Resistance R₁′ corresponding to a reaction resistance of said anode, (2) a parallel circuit of (2a) a capacitor having Capacitance C₂′ corresponding to capacitance of said electric dual layers of said anode and (2b) a series circuit of a resistor having Resistance R₂′ corresponding to said reaction resistance of said anode of said fuel cell and a whorl burg resistor having Resistance R_{2R}′ corresponding to a diffusion resistance of a cathode and (3) a resistor having Resistance R₃′ corresponding to a resistance of a polymer membrane of said fuel cell.

24. The fuel cell system according to claim 23, wherein said volume of said air bleed in said fuel gas provided to said fuel cell is increased when said Capacitance C₁′ is smaller than a prescribed smallest limit.

25. The fuel cell system according to claim 24, wherein said alarm starts and said operation of said fuel cell is stopped in a case when said Capacitance C₁′ is smaller than said prescribed smallest limit even if said volume of said air bleed is increased.

26. The fuel cell system according to claim 23, wherein said volume of said air bleed in said fuel gas provided to said fuel cell is decreased if said Capacitance C1 is larger than said prescribed largest limit.

27. The fuel cell system according to claim 23, wherein said utilizing ratio of said fuel gas provided to said fuel cell is increased if said Resistance R₁′ is smaller than said prescribed smallest limit.

28. The fuel cell system according to claim 23, wherein said utilizing ratio of said fuel gas provided to said fuel cell is decreased if said Resistance R₁′ is larger than said prescribed largest limit.

29. The fuel cell system according to claim 23, where a prescribed recovery is performed in relation to catalyst of said cathode electrode in said fuel cell if said Capacitance C₂′ is smaller than said prescribed smallest limit.

30. The fuel cell system according to claim 29, wherein said alarm starts outward and said operation of said fuel cell is stopped in a case when said Capacitance C₂′ is smaller than said prescribed smallest limit when a prescribed time has past after said performance of said prescribed recovery.

31. The fuel cell system according to claim 23, wherein volume of humidification in said oxidizer gas provided to said fuel cell is decreased if said Resistance R₂′ is smaller than said prescribed smallest limit.

32. The fuel cell system according to claim 23, wherein said volume of humidification in said oxidizer gas provided to said fuel cell is increased if said Resistance R₂′ is larger than said prescribed largest limit.

33. The fuel cell system according to claim 23, wherein said utilizing ratio of oxidizer gas provided to said fuel cell is increased if said Resistance W_{2R}′ is smaller than said prescribed smallest limit.

34. The fuel cell system according to claim 23, wherein said utilizing ratio of oxidizer gas provided to said fuel cell is increased if said Resistance W_{2R}′ is smaller than said prescribed smallest limit.

35. The fuel cell system according to claim 34, wherein said volume of cooling water provided to said fuel cell is decreased if said utilizing ratio of oxidizer gas is decreased more than prescribed times.

36. The fuel cell system according to claim 35, wherein said alarm starts and said operation of said fuel cell is continued after said utilizing ratio of oxidizer gas is further decreased if said volume of cooling water provide to said fuel cell is decreased more than a prescribed volume.

37. The fuel cell system according to claim 23, said volume of cooling water provided to said fuel is increased if said Resistance R₃′ is larger than a prescribed largest limit.

38. The fuel cell system according to claim 1, wherein said load electric current is replaced by alternating current that is placed over direct current and is outputted from said fuel cell, said changes in said load electric current is replaced by changes in frequencies of said alternating current and said calculation in relation to impedance is done based on results of impedance of said fuel cell at multiple frequencies of said alternating current.

39. The fuel cell system according to claim 1, wherein said load electric current is fluctuated at a constant difference, and calculation of impedance is achieved from a frequency function found by using Fourier's transformation on said fluctuating load electric current and a time function found by using Fourier's transformation on voltage response to changes in said load electric current.

40. The fuel cell system according to claim 1, wherein said fuel cell consists of multiple cells, impedance is measured for every cell while a control changes condition for operation for every cell.

41. The fuel cell system according to claim 40, wherein further comprising:
a first wire connects multiple cells while allowing changing amount of electricity to flow through,
a second wire connects a measurement device and said multiple cells,
a switching means for whether to switch connection between said multiple cells and said first wire on or off, and between said multiple cells and said second wire on and off, and
a controlling means for controlling said connections of said first and said second wires by utilizing control signals.

42. The fuel cell system according to claim 1, wherein said fuel cell is connected to an AC/DC inverter in series.

43. A method for operation of a fuel cell system comprising:
a load electric current changing step for changing an amount of load electric current supplied to a fuel cell operated for generating electricity,
a measurement step for measuring voltage responses corresponding to said changes in said load electric current,
a calculation step for calculating impedance of said fuel cells based on result of said measurement in said voltage responses, and
a fuel cell controlling step for changing conditions for operation of said fuel cell by utilizing result of said calculation of said impedance.

44. A program that allows a computer to execute said operation method according to claim 43 comprising:
a load electric current changing step for changing an amount of load electric current supplied to a fuel cell operated for generating electricity,
a calculation step for calculating impedance of said fuel cell based on a result of measurement in voltage responses and
a fuel cell controlling step for changing conditions for operation of said fuel cell by utilizing result of said calculation of said impedance.

45. A recording medium on which said program according to claim 44 is recorded and said program is to be executed by a computer.
